(19) United States
(12) Patent Application Publication
(10) Pub. No.: US 2023/0097607 A1
(43) Pub. Date: Mar. 30, 2023

(54) FIXED ABRASIVE ARTICLES AND METHODS OF FORMING SAME

(71) Applicants: SAINT-GOBAIN ABRASIVES, INC., Worcester, MA (US); SAINT-GOBAIN ABRASIFS, Conflans-Sainte-Honorine (FR)

(72) Inventors: Mateusz MILAK, Torun (PL); Mariken VAN DER GIESSEN-BLEEKER, Eibergen (NL); Nilanjan SARANGI, Shrewsbury, MA (US); Marcin P. BLICHARSKI, Orly (PL); Michal ZALEWSKI, Konin (PL)

(21) Appl. No.: 17/937,114

(22) Filed: Sep. 30, 2022

Related U.S. Application Data
(60) Provisional application No. 63/261,852, filed on Sep. 30, 2021.

(51) Int. Cl. C09K 3/14; B24D 3/32; B24D 18/00

(52) U.S. Cl. CPC C09K 3/1409; B24D 3/32; B24D 18/0009

(57) ABSTRACT

An abrasive article with a bonded abrasive body having a ratio of diameter to thickness of at least 10:1. The abrasive article can include secondary abrasive particles contained in a bond material, wherein the secondary abrasive particles include agglomerated primary abrasive particles.

### CROSS-REFERENCE TO RELATED APPLICATION(S)

This application claims priority under 35 U.S.C. § 119(e) to U.S. Provisional Patent Application No. 63/261,852, filed Sep. 30, 2021, by Mateusz MILAK et al., entitled “FIXED ABRASIVE ARTICLES AND METHODS OF FORMING SAME,” which is assigned to the current assignee hereof and incorporated herein by reference in its entirety for all purposes.

### BACKGROUND

### Field of the Disclosure

The following is directed to fixed abrasive articles, and more particularly, to fixed abrasive articles having excellent comfort of use and performance while maintaining good handfeel.

### Description of the Related Art

Abrasive articles incorporating abrasive particles are useful for various material removal operations, including grinding, finishing, polishing, and the like. Depending upon the type of abrasive material, such abrasive particles can be useful in shaping or grinding various materials in the manufacturing of goods. The industry continues to demand improved abrasive articles having better comfort of use.

### BRIEF DESCRIPTION OF THE DRAWINGS

The present disclosure may be better understood, and its numerous features and advantages made apparent to those skilled in the art by referencing the accompanying drawings.

FIG. 1 includes a perspective view illustration of a fixed abrasive article according to an embodiment.

FIGS. 2 and 3 include images of cross-sections of abrasive articles according to different embodiments.

FIG. 4 includes vibration date on various embodiments and a comparative sample.

### DETAILED DESCRIPTION

The following description in combination with the figures is provided to assist in understanding the teachings provided herein. The following disclosure will focus on specific implementations and embodiments of the teachings. This focus is provided to assist in describing the teachings and should not be interpreted as a limitation on the scope or applicability of the teachings. However, other teachings can certainly be used in this application.

As used herein, the terms “comprises,” “comprising,” “includes,” “including, “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

Embodiments disclosed herein are directed to abrasive articles, including a body including a bond material and agglomerated abrasive particles contained within the bond material. The body can have a particular distribution of porosity throughout.

The abrasive articles described in embodiments herein can be suitable for conducting material removal operations on various types of workpieces, including, for example, but not limited to, metal, glass, etc.

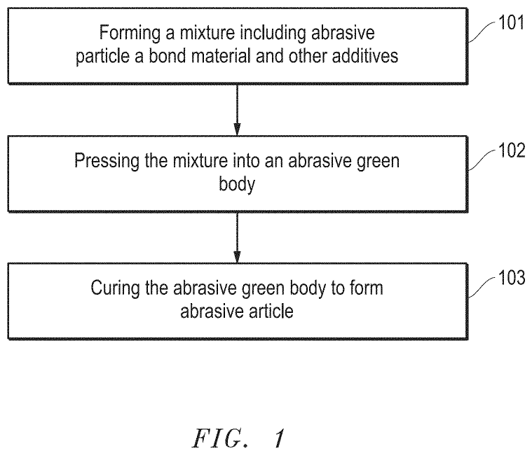

FIG. 1 includes a flowchart illustrating a process of forming an abrasive article in accordance with an embodiment. At step 101, a mixture can be formed, including a bond material, abrasive particles, and optionally other additives. In an embodiment, the mixture does not include pore-forming materials.

In an embodiment, the mixture may include a particular abrasive particle that may facilitate improved manufacturing and/or performance of the abrasive article. In a particular embodiment, the abrasive particles may be secondary abrasive particles that include agglomerated primary abrasive particles. In an embodiment, the agglomerated abrasive particles can include primary abrasive particles and a binder. In an embodiment, the mixture can be free of unagglomerated abrasive particles.

In an embodiment, the mixture may include a particular amount of agglomerated primary abrasive particles that may facilitate improved performance and/or manufacturing of the abrasive article. In an embodiment the mixture can include at least 25 vol % agglomerated primary abrasive particles for a total volume of the mixture at least 26 vol % or at least 27 vol % or at least 28 vol % or at least 29 vol % or at least 30 vol % or at least 31 vol % or at least 32 vol % or at least 33 vol % or at least 34 vol % or at least 35 vol % or at least 36 vol % or at least 37 vol % or at least 38 vol % or at least 39 vol % or at least 40 vol % or at least 41 vol % or at least 42 vol % or at least 43 vol % or at least 44 vol % or at least 45 vol % or at least 46 vol % or at least 47 vol % or at least 48 vol % or at least 49 vol % or at least 50 vol % or at least 51 vol % or at least 52 vol % or at least 53 vol % or at least 54 vol % or at least 55 vol % or at least 56 vol % or at least 57 vol % or at least 58 vol % or at least 59 vol % or at least 60 vol % or at least 61 vol % or at least 62 vol % or at least 63 vol % or at least 64 vol % or at least 65 vol % or at least 66 vol % or at least 67 vol % or at least 68 vol % or at least 69 vol % or at least 70 vol % or at least 71 vol % or at least 72 vol % or at least 73 vol % or at least 74 vol % or at least 75 vol % or at least 76 vol % or at least 77 vol % or at least 78 vol % or at least 79 vol % agglomerated primary abrasive particles for a total volume of the mixture. In an embodiment, the mixture can include no greater than 80 vol % agglomerated primary abrasive particles for a total volume of the mixture, or no greater than or not greater than 79 vol % or not greater than 78 vol % or not greater than 77 vol % or not greater than 76 vol % or not greater than 75 vol % or not greater than 74 vol % or not greater than 73 vol % or not greater than 72 vol % or not greater than 71 vol % or not greater than 70 vol % or not greater than 69 vol % or not greater than 68 vol % or not greater than 67 vol % or not greater than 66 vol % or not greater than 65 vol % or not greater than 64 vol % or not greater than 63 vol % or not greater than 62 vol % or not greater than 61 vol % or not greater than 60 vol % or not greater than 59 vol % or not greater than 58 vol % or not greater than 57 vol % or not greater than 56 vol % or not greater than 55 vol % or not greater than 54 vol % or not greater than 53 vol % or not greater than 52 vol % or not greater than 51 vol % or not greater than 50 vol % or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % agglomerated primary abrasive particles for a total volume of the mixture. It will be appreciated that the amount of agglomerated primary abrasive particles in the mixture may be between any of the minimum and maximum values noted above, including, for example, but not limited to at least 26 vol % and not greater than 58 vol % or at least 31 vol % and not greater than 68 vol %.

In an embodiment, the primary abrasive particles in the mixture may include oxides, carbides, nitrides, borides, super-abrasives, or any combination thereof. In another embodiment, the primary abrasive particles may include a vitreous phase, a polycrystalline phase, or any combination thereof. In a particular embodiment, the primary abrasive particles can comprise brown fused alumina. In a more particular embodiment, the primary abrasive particles can consist of brown fused alumina. In an embodiment, the primary abrasive particles can comprise Al₂O₃, SiO₂, Fe₂O₃, CaO, TiO₂, or a combination thereof.

In an embodiment, the binder can comprise a vitreous binder. In an embodiment, the binder can consist of a vitreous binder. In a particular embodiment, the agglomerated primary abrasive particles consist of brown fused alumina and a vitreous binder system. In an embodiment, the binder can be a vitrified bond composition comprising SiO₂ and B₂O₃. In another embodiment, the binder can comprise Al₂O₃. In a further embodiment, the binder can comprise alkali oxides. In an embodiment, the binder can comprise silica, alkali, alkaline-earth, mixed alkali and alkaline-earth silicates, aluminum silicates, zirconium silicates, hydrated silicates, aluminates, oxides, nitrides, oxynitrides, carbides, oxycarbides, and combinations and derivatives thereof.

In an embodiment, the mixture may include a particular amount of binder that may facilitate improved performance and/or manufacturing of the abrasive article. In an embodiment the mixture can include at least 25 vol % binder for a total volume of the mixture at least 26 vol % or at least 27 vol % or at least 28 vol % or at least 29 vol % or at least 30 vol % or at least 31 vol % or at least 32 vol % or at least 33 vol % or at least 34 vol % or at least 35 vol % or at least 36 vol % or at least 37 vol % or at least 38 vol % or at least 39 vol % or at least 40 vol % or at least 41 vol % or at least 42 vol % or at least 43 vol % or at least 44 vol % or at least 45 vol % or at least 46 vol % or at least 47 vol % or at least 48 vol % or at least 49 vol % or at least 50 vol % or at least 51 vol % or at least 52 vol % or at least 53 vol % or at least 54 vol % or at least 55 vol % or at least 56 vol % or at least 57 vol % or at least 58 vol % or at least 59 vol % or at least 60 vol % or at least 61 vol % or at least 62 vol % or at least 63 vol % or at least 64 vol % or at least 65 vol % or at least 66 vol % or at least 67 vol % or at least 68 vol % or at least 69 vol % or at least 70 vol % or at least 71 vol % or at least 72 vol % or at least 73 vol % or at least 74 vol % or at least 75 vol % or at least 76 vol % or at least 77 vol % or at least 78 vol % or at least 79 vol % binder for a total volume of the mixture. In an embodiment, the mixture can include no greater than 80 vol % binder for a total volume of the mixture, or no greater than or not greater than 79 vol % or not greater than 78 vol % or not greater than 77 vol % or not greater than 76 vol % or not greater than 75 vol % or not greater than 74 vol % or not greater than 73 vol % or not greater than 72 vol % or not greater than 71 vol % or not greater than 70 vol % or not greater than 69 vol % or not greater than 68 vol % or not greater than 67 vol % or not greater than 66 vol % or not greater than 65 vol % or not greater than 64 vol % or not greater than 63 vol % or not greater than 62 vol % or not greater than 61 vol % or not greater than 60 vol % or not greater than 59 vol % or not greater than 58 vol % or not greater than 57 vol % or not greater than 56 vol % or not greater than 55 vol % or not greater than 54 vol % or not greater than 53 vol % or not greater than 52 vol % or not greater than 51 vol % or not greater than 50 vol % or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % binder for a total volume of the mixture. It will be appreciated that the amount of binder in the mixture may be between any of the minimum and maximum values noted above, including, for example, but not limited to at least 26 vol % and not greater than 58 vol % or at least 31 vol % and not greater than 68 vol %.

In an embodiment, the secondary abrasive particles of the mixture may comprise a certain content of primary abrasive particles that may facilitate improved performance and/or manufacturing of the abrasive articles. In an embodiment, at least 50% of the secondary abrasive particles comprise agglomerated primary abrasive particles or at least 55% or at least 60% or at least 65% or at least 70% or at least 75% or at least 80% or at least 85% or at least 90% or at least 95% of the secondary abrasive particles can comprise agglomerated primary abrasive particles, or the secondary abrasive particles may consist of agglomerated primary abrasive particles. In another embodiment, no greater than 99% of the secondary abrasive particles comprise agglomerated primary abrasive particles or no greater than 98% or no greater than 97% or no greater than 96% or no greater than 95% or no greater than 94% or no greater than 93% or no greater than 92% or no greater than 91% or no greater than 90% or no greater than 85% or no greater than 80% or no greater than 75% or no greater than 70% of the secondary abrasive particles comprise agglomerated primary abrasive particles. It will be appreciated that the content of secondary abrasive particles that are agglomerated primary abrasive particles may be between any of the minimum and maximum values noted above, including for example, but not limited to, at least 50% and no greater than 99%, at least 60% and no greater than 70%, or at least 70% and no greater than 96% of the secondary abrasive particles can comprise agglomerated primary abrasive particles.

In an embodiment, the primary abrasive particles of the mixture may comprise a certain wt % of Al₂O₃ that may facilitate improved performance and/or manufacturing of the abrasive articles. In an embodiment, the primary abrasive particles may include at least 90% Al₂O₃ or at least 91% or at least 92% or at least 93% or at least 94% or at least 95% or at least 96% or at least 97% or at least 98% Al₂O₃. In an embodiment, the primary abrasive particles may include no greater than 99.9% Al₂O₃ or no greater than 99.8% or no greater than 99.7% or no greater than 99.6% or no greater than 99.5% or no greater than 99% Al₂O₃It will be appreciated that the primary abrasive particles may include a content of Al₂O₃ that may be between any of the minimum and maximum values noted above, including for example, but not limited to, at least 90% and no greater than 99%, at least 92% and no greater than 99.7%, or at least 91% and no greater than 99.9% Al₂O₃.

In an embodiment, the primary abrasive particles of the mixture may comprise a certain wt % of SiO₂, Fe₂O₃, CaO, and TiO₂ that may facilitate improved performance and/or manufacturing of the abrasive articles. In an embodiment, the primary abrasive particles can include no greater than 1.5% SiO₂. In an embodiment, the primary abrasive particles can include no greater than 0.3% Fe₂O₃. In an embodiment, the primary abrasive particles can include no greater than 0.3% CaO. In an embodiment, the primary abrasive particles can include no greater than 1.5% TiO₂.

In an embodiment, the primary abrasive particles of the mixture may have a particular average grit size (D50) that may facilitate improved performance or manufacturing of the abrasive article. In an embodiment, the primary abrasive particles can have an average grit size of at least 250 microns or at least 275 microns or at least 300 microns or at least 325 microns or at least 350 microns or at least 375 microns or at least 400 microns or at least 425 microns or at least 450 microns or at least 475 microns. In another embodiment, the primary abrasive particles may have an average grit size of no greater than 1000 microns or no greater than 950 microns or no greater than 900 microns or no greater than 850 microns or no greater than 800 microns or no greater than 750 microns or no greater than 700 microns or no greater than 650 microns or no greater than 600 microns. It will be appreciated that the primary abrasive particles may have an average grit size that may be between any of the minimum and maximum values noted above, including, for example, but not limited to, at least 250 microns and no greater than 950 microns, at least 450 microns and no greater than 600 microns or at least 300 microns and no greater than 900 microns.

In an embodiment, the primary abrasive particles of the mixture may have a particular bulk density that may facilitate improved performance or manufacturing of the abrasive article. In an embodiment, the primary abrasive particles can have a bulk density of at least 1.4 g/cm² or at least 1.41 g/cm² or at least 1.42 g/cm² or at least 1.43 g/cm² or at least 1.44 g/cm² or at least 1.45 g/cm² or at least 1.46 g/cm² or at least 1.47 g/cm² or at least 1.48 g/cm² or at least 1.49 g/cm² or at least 1.5 g/cm² or at least 1.51 g/cm² or at least 1.52 g/cm² or at least 1.53 g/cm² or at least 1.54 g/cm² or at least 1.55 g/cm² or at least 1.56 g/cm² or at least 1.57 g/cm² or at least 1.58 g/cm² or at least 1.59 g/cm² or at least 1.6 g/cm². In another embodiment, the primary abrasive particles may have a bulk density of no greater than 2 g/cm² or no greater than 1.99 g/cm² or no greater than 1.98 g/cm² or no greater than 1.97 g/cm² or no greater than 1.96 g/cm² or no greater than 1.95 g/cm² or no greater than 1.94 g/cm² or no greater than 1.93 g/cm² or no greater than 1.92 g/cm² or no greater than 1.91 g/cm² or no greater than 1.90 g/cm² or no greater than 1.89 g/cm² or no greater than 1.88 g/cm² or no greater than 1.87 g/cm² or no greater than 1.86 g/cm² or no greater than 1.85 g/cm² or no greater than 1.84 g/cm² or no greater than 1.83 g/cm² or no greater than 1.82 g/cm² or no greater than 1.81 g/cm² or no greater than 1.80 g/cm² It will be appreciated that the primary abrasive particles may have a bulk density that may be between any of the minimum and maximum values noted above, including for example, but not limited to, at least 1.4 g/cm² and no greater than 2.0 g/cm², at least 1.50 g/cm² and no greater than 1.85 g/cm² or at least 1.6 g/cm² s and no greater than 1.81 g/cm².

In an embodiment, the binder can comprise a particular content of SiO₂ and B₂O₃ particles that may facilitate improved manufacturing and/or performance of the abrasive article. In an embodiment, the binder can comprise at least 30% SiO₂ and B₂O₃ or at least 31% or at least 32% or at least 33% or at least 34% or at least 35% or at least 36% or at least 37% or at least 38% or at least 39% or at least 40% or at least 41% or at least 42% or at least 43% or at least 44% or at least 45% or at least 46% or at least 47% or at least 48% or at least 49% or at least 50% or at least 51% or at least 52% or at least 53% or at least 54% or at least 55% or at least 56% or at least 57% or at least 58% or at least 59% or at least 60% SiO₂ and B₂O₃. In another embodiment, the binder can comprise no greater than 99% SiO₂ and B₂O₃ or no greater than 98% or no greater than 95% or no greater than 90% or no greater than 85% or no greater than 80% or no greater than 75% or no greater than 70% SiO₂ and B₂O₃. It will be appreciated that the binder may include a content of SiO₂ and B₂O₃ that may be between any of the minimum and maximum values noted above, including, for example, but not limited to, at least 30% and no greater than 99%, at least 39% and no greater than 90%, or at least 50% and no greater than 99% SiO₂ and B₂O₃.

In an embodiment, the binder may comprise a certain content of Al₂O₃ that may facilitate improved performance and/or manufacturing of the abrasive articles. In an embodiment, the primary abrasive particles may include at least 1% Al₂O₃ or at least 2% or at least 3% or at least 4% or at least 5% or at least 6% or at least 7% or at least 8% or at least 9% or at least 10% or at least 11% or at least 12% or at least 13% or at least 14% Al₂O₃. In an embodiment, the primary abrasive particles may no greater than 40% Al₂O₃ or no greater than 35% or no greater than 30% or no greater than 25% or no greater than 20% Al₂O₃. It will be appreciated that the primary abrasive particles may include a content of Al₂O₃ that may be between any of the minimum and maximum values noted above, including for example, but not limited to, at least 1% and no greater than 40%, at least 10% and no greater than 30%, or at least 1% and no greater than 20% Al₂O₃.

In an embodiment, the binder may comprise a certain content of alkali oxides that may facilitate improved performance and/or manufacturing of the abrasive article. In an embodiment, the primary abrasive particles may include at least 1% alkali oxides or at least 2% or at least 3% or at least 4% or at least 5% or at least 6% or at least 7% or at least 8% or at least 9% or at least 10% or at least 11% or at least 12% or at least 13% or at least 14% alkali oxides. In an embodiment, the primary abrasive particles may no greater than 40% alkali oxides or no greater than 35% or no greater than 30% or no greater than 25% or no greater than 20% alkali oxides. It will be appreciated that the primary abrasive particles may include a content of alkali oxides that may be between any of the minimum and maximum values noted above, including for example, but not limited to, at least 1% and no greater than 40%, at least 10% and no greater than 30%, or at least 1% and no greater than 20% alkali oxides.

In an embodiment, the binder may comprise alkali Earth oxides. In an embodiment, the binder may comprise no greater than 1% alkali Earth oxides.

In an embodiment, the binder may have a particular melting temperature that may facilitate improved performance and/or manufacturing of the abrasive article. In an embodiment, the melting temperature can be is at least 500° C. or at least 550° C. or at least 600° C. or at least 650° C. or at least 700° C. or at least 750° C. or at least 800° C. In an embodiment, the melting temperature can be no greater than 1600° C. or no greater than 1550° C. or no greater than 1500° C. or no greater than 1450° C. or no greater than 1400° C. or no greater than 1350° C. or no greater than 1300° C. It will be appreciated that the primary abrasive particles may include a content of alkali oxides that may be between any of the minimum and maximum values noted above, including for example, but not limited to, at least 800° C. and no greater than 1300° C., or at least 750° C. and no greater than 1500° C.

In an embodiment, the secondary abrasive particles may have a particular average size relative to the primary abrasive particles that may facilitate improved performance or manufacturing of the abrasive article. In an embodiment, the secondary abrasive particles have an average size of 2 times the average size of the primary abrasive particles or at least 3 times or at least 4 times or at least 5 times or at least 6 times or at least 7 times or at least 8 times or at least 9 times or at least 10 times or at least 11 times or at least 12 times or at least 13 times or at least 14 times or at least 15 times or at least 16 times or at least 17 times or at least 18 times or at least 19 times or at least 20 times the average size of the primary abrasive particles. In an embodiment, the secondary abrasive particles can be no greater than 100 times the size of the primary abrasive particles, or no greater than 90 times or no greater than 80 times or no greater than 70 times or no greater than 60 times or no greater than 50 times or no greater than 30 times or no greater than 20 time the size of the primary abrasive particles. It will be appreciated that the relative size of the primary and secondary abrasive particles can be between any of the minimum and maximum values noted above, including, for example, at least 2 times and no greater than 80 times or at least 13 times and no greater than 60 times.

In an embodiment, the mixture may include a particular bond material that may facilitate improved performance or manufacturing of the abrasive article. In an embodiment, the bond material can comprise an organic bond material. In an embodiment, the bond material can consist of an organic bond material.

At step 102 of FIG. 1, the mixture can be pressed into a green abrasive body. The green abrasive body can be in the shape of a wheel. The mixture may be pressed with a particular pressure that may facilitate improved performance or manufacturing of the abrasive article. In an embodiment, the mixture may be pressed with a pressure of at least 30 bar or at least 31 bar or at least 32 bar or at least 33 bar or at least 34 bar or at least 35 bar or at least 36 bar or at least 37 bar or at least 38 bar or at least 39 bar or at least 40 bar or at least 41 bar or at least 42 bar or at least 43 bar or at least 44 bar or at least 45 bar or at least 46 bar or at least 47 bar or at least 48 bar or at least 50 bar. In an embodiment, the mixture may be pressed with a pressure of no greater than 275 bar or no greater than 270 bar or no greater than 265 bar or no greater than 260 bar or no greater than 255 bar or no greater than 250 bar or no greater than 245 bar or no greater than 240 bar or no greater than 235 bar or no greater than 230 bar or no greater than 225 bar or no greater than 220 bar or no greater than 215 bar or no greater than 210 bar or no greater than 205 bar or no greater than 200 bar or no greater than 195 bar or no greater than 190 bar or no greater than 185 bar or no greater than 180 bar or no greater than 175 bar or no greater than 170 bar or no greater than 165 bar or no greater than 160 bar or no greater than 155 bar or no greater than 150 bar or no greater than 145 bar or no greater than 140 bar or no greater than 135 bar or no greater than 130 bar or no greater than 125 bar. It will be appreciated that the pressure may be between any of the minimum and maximum values noted above, including for example, but not limited to at least 30 bar and no greater than 180 bar or at least 50 bar and no greater than 175 bar.

At step 103 of FIG. 1, the green abrasive body can be cured to form an abrasive article. The abrasive article can comprise a bonded abrasive body comprising secondary abrasive particles contained in a bond material. In an embodiment, the green abrasive body may be cured at a particular temperature that may facilitate improved performance or manufacturing of the abrasive article. In an embodiment, the green abrasive body can be cured at a temperature of at least 150° C. or at least 152° C. or at least 154° C. or at least 156° C. or at least 158° C. or at least 160° C. or at least 161° C. or at least 162° C. or at least 163° C. at least 164° C. or at least 165° C. or at least 166° C. or at least 167° C. or at least 168° C. or at least 169° C. or at least 170° C. In an embodiment, the green abrasive body can be cured at a temperature of not greater than 225° C. or no greater than 220° C. or no greater than 215° C. or no greater than 210° C. or no greater than 205° C. or no greater than 200° C. or no greater than 195° C. or no greater than 190° C. or no greater than 185° C. or no greater than 180° C. or no greater than 175° C. It will be appreciated that the curing temperature may be between any of the minimum and maximum values noted above, including for example, but not limited to, at least 150° C. and no greater than 200° C. or at least 158° C. and no greater than 175° C.

In an embodiment, the bonded abrasive body may include particular abrasive particles that may facilitate improved manufacturing and/or performance of the abrasive article. In a particular embodiment, the abrasive particles may be secondary abrasive particles that include agglomerated primary abrasive particles. In an embodiment, the agglomerated abrasive particles can include primary abrasive particles and a binder. In an embodiment, the bonded abrasive body can be free of unagglomerated abrasive particles.

In an embodiment, the bonded abrasive body may include a particular amount of abrasive particles that may facilitate improved manufacturing or performance of the bonded abrasive body. In an embodiment, the bonded abrasive body may include at least 10 vol % abrasive particles for a total volume of the bonded abrasive body or at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % abrasive particles for a total volume of the bonded abrasive body. In another embodiment, the bonded abrasive body may include comprises not greater than 50 vol % abrasive particles for a total volume of the bonded abrasive body or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % abrasive particles for a total volume of the bonded abrasive body. It will be appreciated that the amount of abrasive particles may be between any of the minimum and maximum values noted above, including, for example, but not limited to, at least 10 vol % and not greater than 39 vol % or at least 21 vol % and not greater than 37 vol %.

In an embodiment, the primary abrasive particles in the bonded abrasive body may include oxides, carbides, nitrides, borides, super-abrasives, or any combination thereof. In another embodiment, the primary abrasive particles may include a vitreous phase, a polycrystalline phase, or any combination thereof. In a particular embodiment, the primary abrasive particles can comprise brown fused alumina. In a more particular embodiment, the primary abrasive particles can consist of brown fused alumina. In an embodiment, the primary abrasive particles can comprise Al₂O₃, SiO₂, Fe₂O₃, CaO, TiO₂, or a combination thereof.

In an embodiment, the bonded abrasive body may include a particular amount of primary abrasive particles that may facilitate improved manufacturing or performance of the bonded abrasive body. In an embodiment, the bonded abrasive body may include at least 10 vol % primary abrasive particles for a total volume of the bonded abrasive body or at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % primary abrasive particles for a total volume of the bonded abrasive body. In another embodiment, the bonded abrasive body may include comprises not greater than 50 vol % primary abrasive particles for a total volume of the bonded abrasive body or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % primary abrasive particles for a total volume of the bonded abrasive body. It will be appreciated that the amount of primary abrasive particles may be between any of the minimum and maximum values noted above, including, for example, but not limited to, at least 10 vol % and not greater than 39 vol % or at least 21 vol % and not greater than 37 vol %.

In an embodiment, the binder can comprise a vitreous binder. In an embodiment, the binder can consist of a vitreous binder. In a particular embodiment, the agglomerated primary abrasive particles consist of brown fused alumina and a vitreous binder system. In an embodiment, the binder can be a vitrified bond composition comprising SiO₂ and B₂O₃. In another embodiment, the binder can comprise Al₂O₃. In a further embodiment, the binder can comprise alkali oxides. In an embodiment, the binder can comprise silica, alkali, alkaline-earth, mixed alkali and alkaline-earth silicates, aluminum silicates, zirconium silicates, hydrated silicates, aluminates, oxides, nitrides, oxynitrides, carbides, oxycarbides, and combinations and derivatives thereof.

In an embodiment, the secondary abrasive particles of the bonded abrasive body may comprise a certain content of primary abrasive particles that may facilitate improved performance and/or manufacturing of the abrasive articles. In an embodiment, at least 50% of the secondary abrasive particles comprise agglomerated primary abrasive particles or at least 55% or at least 60% or at least 65% or at least 70% or at least 75% or at least 80% or at least 85% or at least 90% or at least 95% of the secondary abrasive particles can comprise agglomerated primary abrasive particles, or the secondary abrasive particles may consist of agglomerated primary abrasive particles. In another embodiment, no greater than 99% of the secondary abrasive particles comprise agglomerated primary abrasive particles or no greater than 98% or no greater than 97% or no greater than 96% or no greater than 95% or no greater than 94% or no greater than 93% or no greater than 92% or no greater than 91% or no greater than 90% or no greater than 85% or no greater than 80% or no greater than 75% or no greater than 70% of the secondary abrasive particles comprise agglomerated primary abrasive particles. It will be appreciated that the content of secondary abrasive particles that are agglomerated primary abrasive particles may be between any of the minimum and maximum values noted above, including for example, but not limited to, at least 50% and no greater than 99%, at least 60% and no greater than 70%, or at least 70% and no greater than 96% of the secondary abrasive particles can comprise agglomerated primary abrasive particles.

In an embodiment, the primary abrasive particles of the bonded abrasive body may comprise a certain wt % of Al₂O₃ that may facilitate improved performance and/or manufacturing of the abrasive articles. In an embodiment, the primary abrasive particles may include at least 90% Al₂O₃ or at least 91% or at least 92% or at least 93% or at least 94% or at least 95% or at least 96% or at least 97% or at least 98% Al₂O₃. In an embodiment, the primary abrasive particles may include no greater than 99.9% Al₂O₃ or no greater than 99.8% or no greater than 99.7% or no greater than 99.6% or no greater than 99.5% or no greater than 99% Al₂O₃It will be appreciated that the primary abrasive particles may include a content of Al₂O₃ that may be between any of the minimum and maximum values noted above, including for example, but not limited to, at least 90% and no greater than 99%, at least 92% and no greater than 99.7%, or at least 91% and no greater than 99.9% Al₂O₃.

In an embodiment, the primary abrasive particles of the bonded abrasive body may comprise a certain wt % of SiO₂, Fe₂O₃, CaO, and TiO₂ that may facilitate improved performance and/or manufacturing of the abrasive articles. In an embodiment, the primary abrasive particles can include no greater than 1.5% SiO₂. In an embodiment, the primary abrasive particles can include no greater than 0.3% Fe₂O₃. In an embodiment, the primary abrasive particles can include no greater than 0.3% CaO. In an embodiment, the primary abrasive particles can include no greater than 1.5% TiO₂.

In an embodiment, the primary abrasive particles of the bonded abrasive body may have a particular average grit size (D50) that may facilitate improved performance or manufacturing of the abrasive article. In an embodiment, the primary abrasive particles can have an average grit size of at least 250 microns or at least 275 microns or at least 300 microns or at least 325 microns or at least 350 microns or at least 375 microns or at least 400 microns or at least 425 microns or at least 450 microns or at least 475 microns. In another embodiment, the primary abrasive particles may have an average grit size of no greater than 1000 microns or no greater than 950 microns or no greater than 900 microns or no greater than 850 microns or no greater than 800 microns or no greater than 750 microns or no greater than 700 microns or no greater than 650 microns or no greater than 600 microns. It will be appreciated that the primary abrasive particles may have an average grit size that may be between any of the minimum and maximum values noted above, including, for example, but not limited to, at least 250 microns and no greater than 950 microns, at least 450 microns and no greater than 600 microns or at least 300 microns and no greater than 900 microns.

In an embodiment, the primary abrasive particles of the bonded abrasive body may have a particular bulk density that may facilitate improved performance or manufacturing of the abrasive article. In an embodiment, the primary abrasive particles can have a bulk density of at least 1.4 g/cm² or at least 1.41 g/cm² or at least 1.42 g/cm² or at least 1.43 g/cm² or at least 1.44 g/cm² or at least 1.45 g/cm² or at least 1.46 g/cm² or at least 1.47 g/cm² or at least 1.48 g/cm² or at least 1.49 g/cm² or at least 1.5 g/cm² or at least 1.51 g/cm² or at least 1.52 g/cm² or at least 1.53 g/cm² or at least 1.54 g/cm² or at least 1.55 g/cm² or at least 1.56 g/cm² or at least 1.57 g/cm² or at least 1.58 g/cm² or at least 1.59 g/cm² or at least 1.6 g/cm². In another embodiment, the primary abrasive particles may have a bulk density of no greater than 2 g/cm² or no greater than 1.99 g/cm² or no greater than 1.98 g/cm² or no greater than 1.97 g/cm² or no greater than 1.96 g/cm² or no greater than 1.95 g/cm² or no greater than 1.94 g/cm² or no greater than 1.93 g/cm² or no greater than 1.92 g/cm² or no greater than 1.91 g/cm² or no greater than 1.90 g/cm² or no greater than 1.89 g/cm² or no greater than 1.88 g/cm² or no greater than 1.87 g/cm² or no greater than 1.86 g/cm² or no greater than 1.85 g/cm² or no greater than 1.84 g/cm² or no greater than 1.83 g/cm² or no greater than 1.82 g/cm² or no greater than 1.81 g/cm² or no greater than 1.80 g/cm² It will be appreciated that the primary abrasive particles may have a bulk density that may be between any of the minimum and maximum values noted above, including for example, but not limited to, at least 1.4 g/cm² and no greater than 2.0 g/cm², at least 1.50 g/cm² and no greater than 1.85 g/cm² or at least 1.6 g/cm² s and no greater than 1.81 g/cm².

In an embodiment, the binder can comprise a particular content of SiO₂ and B₂O₃ particles that may facilitate improved manufacturing and/or performance of the abrasive article. In an embodiment, the binder can comprise at least 30% SiO₂ and B₂O₃ or at least 31% or at least 32% or at least 33% or at least 34% or at least 35% or at least 36% or at least 37% or at least 38% or at least 39% or at least 40% or at least 41% or at least 42% or at least 43% or at least 44% or at least 45% or at least 46% or at least 47% or at least 48% or at least 49% or at least 50% or at least 51% or at least 52% or at least 53% or at least 54% or at least 55% or at least 56% or at least 57% or at least 58% or at least 59% or at least 60% SiO₂ and B₂O₃. In another embodiment, the binder can comprise no greater than 99% SiO₂ and B₂O₃ or no greater than 98% or no greater than 95% or no greater than 90% or no greater than 85% or no greater than 80% or no greater than 75% or no greater than 70% SiO₂ and B₂O₃. It will be appreciated that the binder may include a content of SiO₂ and B₂O₃ that may be between any of the minimum and maximum values noted above, including, for example, but not limited to, at least 30% and no greater than 99%, at least 39% and no greater than 90%, or at least 50% and no greater than 99% SiO₂ and B₂O₃.

In an embodiment, the binder may comprise a certain content of Al₂O₃ that may facilitate improved performance and/or manufacturing of the abrasive articles. In an embodiment, the primary abrasive particles may include at least 1% Al₂O₃ or at least 2% or at least 3% or at least 4% or at least 5% or at least 6% or at least 7% or at least 8% or at least 9% or at least 10% or at least 11% or at least 12% or at least 13% or at least 14% Al₂O₃. In an embodiment, the primary abrasive particles may no greater than 40% Al₂O₃ or no greater than 35% or no greater than 30% or no greater than 25% or no greater than 20% Al₂O₃It will be appreciated that the primary abrasive particles may include a content of Al₂O₃ that may be between any of the minimum and maximum values noted above, including for example, but not limited to, at least 1% and no greater than 40%, at least 10% and no greater than 30%, or at least 1% and no greater than 20% Al₂O₃.

In an embodiment, the binder may comprise a certain content of alkali oxides that may facilitate improved performance and/or manufacturing of the abrasive article. In an embodiment, the primary abrasive particles may include at least 1% alkali oxides or at least 2% or at least 3% or at least 4% or at least 5% or at least 6% or at least 7% or at least 8% or at least 9% or at least 10% or at least 11% or at least 12% or at least 13% or at least 14% alkali oxides. In an embodiment, the primary abrasive particles may no greater than 40% alkali oxides or no greater than 35% or no greater than 30% or no greater than 25% or no greater than 20% alkali oxides. It will be appreciated that the primary abrasive particles may include a content of alkali oxides that may be between any of the minimum and maximum values noted above, including for example, but not limited to, at least 1% and no greater than 40%, at least 10% and no greater than 30%, or at least 1% and no greater than 20% alkali oxides.

In an embodiment, the binder may comprise alkali Earth oxides. In an embodiment, the binder may comprise no greater than 1% alkali Earth oxides.

In an embodiment, the binder may have a particular melting temperature that may facilitate improved performance and/or manufacturing of the abrasive article. In an embodiment, the melting temperature can be is at least 500° C. or at least 550° C. or at least 600° C. or at least 650° C. or at least 700° C. or at least 750° C. or at least 800° C. In an embodiment, the melting temperature can be no greater than 1600° C. or no greater than 1550° C. or no greater than 1500° C. or no greater than 1450° C. or no greater than 1400° C. or no greater than 1350° C. or no greater than 1300° C. It will be appreciated that the primary abrasive particles may include a content of alkali oxides that may be between any of the minimum and maximum values noted above, including for example, but not limited to, at least 800° C. and no greater than 1300° C., or at least 750° C. and no greater than 1500° C.

In an embodiment, the secondary abrasive particles may have a particular average size relative to the primary abrasive particles that may facilitate improved performance or manufacturing of the abrasive article. In an embodiment, the secondary abrasive particles have an average size of 2 times the average size of the primary abrasive particles or at least 3 times or at least 4 times or at least 5 times or at least 6 times or at least 7 times or at least 8 times or at least 9 times or at least 10 times or at least 11 times or at least 12 times or at least 13 times or at least 14 times or at least 15 times or at least 16 times or at least 17 times or at least 18 times or at least 19 times or at least 20 times the average size of the primary abrasive particles. In an embodiment, the secondary abrasive particles can be no greater than 100 times the size of the primary abrasive particles, or no greater than 90 times or no greater than 80 times or no greater than 70 times or no greater than 60 times or no greater than 50 times or no greater than 30 times or no greater than 20 time the size of the primary abrasive particles. It will be appreciated that the relative size of the primary and secondary abrasive particles can be between any of the minimum and maximum values noted above, including, for example, at least 2 times and no greater than 80 times or at least 13 times and no greater than 60 times.

In an embodiment, the bonded abrasive body may include a particular bond material that may facilitate improved performance or manufacturing of the abrasive article. In an embodiment, the bond material can comprise an organic bond material. In an embodiment, the bond material can consist of an organic bond material.

In an embodiment, the bonded abrasive body may include a particular amount of bond material that may facilitate improved manufacturing or performance of the bonded abrasive body. In an embodiment, the bonded abrasive body may include at least 10 vol % bond material for a total volume of the bonded abrasive body or at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % or at least 31 vol % or at least 32 vol % or at least 33 vol % or at least 34 vol % or at least 35 vol % or at least 36 vol % or at least 37 vol % or at least 38 vol % or at least 39 vol % or at least 40 vol % bond material for a total volume of the bonded abrasive body. In another embodiment, the bonded abrasive body may include not greater than 55 vol % bond material for a total volume of the bonded abrasive body or not greater than 54 vol % or not greater than 53 vol % or not greater than 52 vol % or not greater than 51 vol % or not greater than 50 vol % or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % bond material for a total volume of the bonded abrasive body. It will be appreciated that the amount of bond material may be between any of the minimum and maximum values noted above, including, for example, but not limited to, at least 10 vol % and not greater than 39 vol % or at least 34 vol % and not greater than 37 vol %.

In an embodiment, the bonded abrasive body can comprise porosity. In an embodiment, the porosity can be closed porosity. In an embodiment, the porosity can be interconnected porosity. In an embodiment, a majority of the porosity can be closed porosity. In an embodiment, the body does not include pore-forming materials. Pores can be categorized as small (0.175 mm diameter or less), medium (0.175-1.06 mm diameter), or large (over 1.06 mm diameter).

In an embodiment, the bonded abrasive body may include a particular amount of porosity that may facilitate improved manufacturing or performance of the bonded abrasive body. In an embodiment, the bonded abrasive body may include at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % porosity for a total volume of the bonded abrasive body. In another embodiment, the bonded abrasive body may include comprises not greater than 50 vol % porosity for a total volume of the bonded abrasive body or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % or not greater than 29 vol % or not greater than 28 vol % or not greater than 27 vol % or not greater than 26 vol % or not greater than 25 vol % or not greater than 24 vol % or not greater than 23 vol % or not greater than 22 vol % or not greater than 21 vol % or not greater than 20 vol % porosity for a total volume of the bonded abrasive body. It will be appreciated that the amount of porosity may be between any of the minimum and maximum values noted above, including, for example, but not limited to, at least 10 vol % and not greater than 39 vol % or at least 21 vol % and not greater than 37 vol %.

In an embodiment, the bonded abrasive body can include a particular percentage of large porosity that may facilitate improved performance or manufacturing of the abrasive article. In an embodiment, at least 18% of the porosity by volume can be large porosity or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40% or at least 41% or at least 42% or at least 43% or at least 44% or at least 45% or at least 46% or at least 47% or at least 48% or at least 49% or at least 50% or at least 51% or at least 52% or at least 53% or at least 54% or at least 55% or at least 56% or at least 57% or at least 58% or at least 59% of the porosity can be large porosity. In an embodiment, no greater than 99% of the porosity can be large porosity or no greater than 98% or no greater than 95% or no greater than 90% or no greater than 85% or no greater than 80% or no greater than 75% or no greater than 70% or no greater than 65% or no greater than 60% of the porosity can be large porosity. It will be appreciated that the amount of large porosity can be between any of the minimum and maximum values noted above, including, for example, but not limited to, at least 19% and not greater than 95% or at least 36% and not greater than 95%.

In an embodiment, the bonded abrasive body can have a particular ratio of large porosity to small porosity that may facilitate improved performance or manufacturing of the abrasive article. In an embodiment the ratio of large porosity to small porosity can be at least 0.4 or at least 0.5 or at least 0.6 or at least 0.7 or at least 0.8 or at least 0.9 or at least 1.0 or at least 1.1 or at least 1.2 or at least 1.3 or at least 1.4 or at least 1.5 or at least 1.6 or at least 1.7 or at least 1.8 or at least 1.9 or at least 2.0 or at least 2.1 or at least 2.2 or at least 2.3 or at least 2.4 or at least 2.5 or at least 2.6 or at least 2.7 or at least 2.8 or at least 2.9 or at least 3.0 or at least 3.1 or at least 3.2 or at least 3.3 or at least 3.4 or at least 3.5 or at least 3.6 or at least 3.7 or at least 3.8 or at least 3.9 or at least 4.0. In an embodiment, the ratio of large porosity to small porosity can be no greater than 10 or no greater than 9 or no greater than 8 or no greater than 7 or no greater than 6 or no greater than 5. It will be appreciated that the ratio of large porosity to small porosity can be between any of the minimum and maximum values noted above, including, for example, but not limited to at least 0.4 and not greater than 3.6 or at least 1.7 and not greater than 3.0.

In an embodiment, the bonded abrasive body can have a particular large porosity distribution factor that may facilitate improved performance or manufacturing of the abrasive article. Porosity distribution factors were calculated for each sample by dividing the difference between the amount of inner diameter porosity and outer diameter porosity by the total amount of porosity. In an embodiment, the bonded abrasive body can have a large porosity distribution factor of no greater than 0.95 or no greater than 0.9 or no greater than 0.85 or no greater than 0.8 or no greater than 0.75 or no greater than 0.7 or no greater than 0.65 or no greater than 0.6 or no greater than 0.55 or no greater than 0.5 or no greater than 0.45 or no greater than 0.4 or no greater than 0.35 or no greater than 0.3 or no greater than 0.25 or no greater than 0.2. In an embodiment, the bonded abrasive body can have a large porosity distribution factor of at least 0.01 or at least 0.2 or at least 0.03 or at least 0.04 or at least 0.05 or at least 0.06 or at least 0.07 or at least 0.08 or at least 0.09 or at least 0.10 or at least 0.11 or at least 0.12 or at least 0.13 or at least 0.14 or at least 0.15. It will be appreciated that the large porosity distribution factor may be between any of the minimum and maximum values noted above, including, for example, but not limited to, at least 0.01 and no greater than 0.85, or at least 0.02 and no greater than 0.2.

In an embodiment, the bonded abrasive body can have a particular porosity distribution factor that may facilitate improved performance or manufacturing of the abrasive article. Porosity distribution factors were calculated for each sample by dividing the difference between the amount of inner diameter porosity and outer diameter porosity by the total amount of porosity. Inner diameter porosity includes any pores that are closer to the inner diameter than the outer diameter of the bonded abrasive body. In an embodiment, the bonded abrasive body can have a porosity distribution factor of no greater than 0.35 or no greater than 0.3 or no greater than 0.25 or no greater than 0.2. In an embodiment, the bonded abrasive body can have a porosity distribution factor of at least 0.01 or at least 0.2 or at least 0.03 or at least 0.04 or at least 0.05 or at least 0.06 or at least 0.07 or at least 0.08 or at least 0.09 or at least 0.10. It will be appreciated that the porosity distribution factor may be between any of the minimum and maximum values noted above, including, for example, but not limited to, at least 0.01 and no greater than 0.35, or at least 0.02 and no greater than 0.2.

In an embodiment, the bonded abrasive body can include pores having a particular pore spacing distance distribution that may facilitate improved manufacturing and/or performance of the article. Pore spacing can be determined by imaging an article in 3D with a resolution of 3 μm/voxel using an X-ray computed-tomography scanner (VTomeX from GE). The pore detection can be based on a grey level segmentation. Neighboring pores can be identified using Delaunay triangulation (See Golias, N. A., & Dutton, R. W. (1997). Delaunay triangulation and 3D adaptive mesh generation. Finite elements in analysis and design, 25 (3-4), (331-341.) Pore spacing can alternatively be measured using a 2D cross section. When using a 2D cross section, the distance between each pore and its closest neighbor can be measured. The distance between neighboring pores can be measured using image analysis software and the distribution can be plotted.

In an embodiment, the bonded abrasive body can have a mean pore spacing distance that may facilitate improved manufacturing and/or performance of the article. In an embodiment, the mean pore spacing distance may be, at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm. In an embodiment, the mean pore spacing distance may be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm. It will be appreciated that the mean pore spacing distance may be between any of the minimum and maximum numbers noted above, including for example, but not limited to, at least 0.1 mm and not greater than 5 mm or at 1.3 mm and not greater than 2.5 mm.

In an embodiment, the bonded abrasive body can have a pore spacing distance standard deviation that may facilitate improved manufacturing and/or performance of the article. The standard deviation can be calculated from a pore spacing distribution obtained from the methods disclosed in this application. In an embodiment, the pore spacing distance standard deviation may be, at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm. In an embodiment, the pore spacing distance standard deviation may be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm. It will be appreciated that the pore spacing distance standard deviation may be between any of the minimum and maximum numbers noted above, including for example, but not limited to, at least 0.1 mm and not greater than 5 mm or at 1.3 mm and not greater than 2.5 mm.

In an embodiment, the bonded abrasive body can have a median pore spacing distance, PS50, which may facilitate improved manufacturing and/or performance of the article. In an embodiment, the PS50 may be, at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm. In an embodiment, the PS50 may be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm. It will be appreciated that the PS50 may be between any of the minimum and maximum numbers noted above, including for example, but not limited to, at least 0.1 mm and not greater than 5 mm or at 1.3 mm and not greater than 2.5 mm.

In an embodiment, the bonded abrasive body can have a 25^{th} percentile pore spacing distance, PS25, which may facilitate improved manufacturing and/or performance of the article. PS25 is the 25th percentile of a pore spacing distribution obtained according to the methods disclosed in this application. 25% of the pore spacings are below the PS25, and 75% are above. In an embodiment, the PS25 may be, at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm. In an embodiment, the PS25 may be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm. It will be appreciated that the PS25 may be between any of the minimum and maximum numbers noted above, including for example, but not limited to, at least 0.1 mm and not greater than 5 mm or at 1.3 mm and not greater than 2.5 mm.

In an embodiment, the bonded abrasive body can have a PS10 which may facilitate improved manufacturing and/or performance of the article. PS10 is the 10th percentile of a pore spacing distribution obtained according to the methods disclosed in this application. 10% of the pore spacings are below the PS10, and 90% are above. In an embodiment, the PS10 may be, at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm. In an embodiment, the PS10 may be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm. It will be appreciated that the PS10 may be between any of the minimum and maximum numbers noted above, including for example, but not limited to, at least 0.1 mm and not greater than 5 mm or at 1.3 mm and not greater than 2.5 mm.

In an embodiment, the bonded abrasive body can have a PS75 which may facilitate improved manufacturing and/or performance of the article. PS75 is the 75th percentile of a pore spacing distribution obtained according to the methods disclosed in this application. 75% of the pore spacings are below the PS75, and 25% are above. In an embodiment, the PS75 may be, at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm. In an embodiment, the PS75 may be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm. It will be appreciated that the PS75 may be between any of the minimum and maximum numbers noted above, including for example, but not limited to, at least 0.1 mm and not greater than 5 mm or at 1.3 mm and not greater than 2.5 mm.

In an embodiment, the bonded abrasive body can have a PS90 which may facilitate improved manufacturing and/or performance of the article. PS90 is the 90th percentile of a pore spacing distribution obtained according to the methods disclosed in this application. 90% of the pore spacings are below the PS90, and 10% are above. In an embodiment, the PS90 may be, at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm. In an embodiment, the PS90 may be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm. It will be appreciated that the PS90 may be between any of the minimum and maximum numbers noted above, including for example, but not limited to, at least 0.1 mm and not greater than 5 mm or at 1.3 mm and not greater than 2.5 mm.

In an embodiment, the bonded abrasive body can have a particular average neighboring pore count which may facilitate improved manufacturing and/or performance of the article. In an embodiment, the average neighboring pore count can be at least at least 5.25 or at least 5.5 or at least 5.75 or at least 6 or at least 6.25 or at least 6.5 or at least 6.75 or at least 7 or at least 7.25 or at least 7.5 or at least 7.75 or at least 8 or at least 8.25 or at least 8.5 or at least 8.75 or at least 9. In an embodiment the average neighboring pore count can be not greater than 20 or not greater than 19 or not greater than 18 or not greater than 17 or not greater than 16 or not greater than 15 or not greater than 14 or not greater than 13 or not greater than 12 or not greater than 11 or not greater than 10. It will be appreciated that the average neighboring poor count may be between any of the minimum and maximum numbers noted above, including for example, but not limited to, at least 5.25 and not greater than 17 or at least 6.5 and not greater than 12.

In an embodiment, the bonded abrasive body can have a particular a large neighboring pore count which may facilitate improved manufacturing and/or performance of the article. In an embodiment a large neighboring pore count can be at least 0.05 or at least 0.1 or at least 0.15 or at least 0.2 or at least 0.25 or at least 0.3 or at least 0.35 or at least 0.4 or at least 0.45 or at least 0.5 or at least 0.55. In an embodiment the large neighboring pore count can be not greater than 2 or not greater than 1.9 or not greater than 1.8 or not greater than 1.7 or not greater than 1.6 or not greater than 1.5 or not greater than 1.4 or not greater than 1.3 or not greater than 1.2 or not greater than 1.1 or not greater than 1.0 or not greater than 0.9 or not greater than 0.8 or not greater than 0.7 or not greater than 0.6. It will be appreciated that the large neighboring pore count may be between any of the minimum and maximum numbers noted above, including for example, but not limited to, at least 0.3 and not greater than 1.8 or at least 0.15 and not greater than 0.6.

In an embodiment, the bonded abrasive body can have a particular a medium neighboring pore count which may facilitate improved manufacturing and/or performance of the article. In an embodiment the medium neighboring pore count can be at least 1.4 or at least 1.5 or at least 1.6 or at least 1.7 or at least 1.8 or at least 1.9 or at least 2.0 or at least 2.1 or at least 2.2 or at least 2.3 or at least 2.4 or at least 2.5 or at least 2.6 or at least 2.7 or at least 2.8 or at least 2.9. In an embodiment, the medium neighboring pore count can be not greater than 5 or not greater than 4.75 or not greater than 4.5 or not greater than 4.25 or not greater than 4 or not greater than 3.75 or not greater than 3.5 or not greater than 3.25 or not greater than 3. It will be appreciated that the medium neighboring pore count may be between any of the minimum and maximum numbers noted above, including for example, but not limited to, at least 2.0 and not greater than 3.25 or at least 2.4 and not greater than 4.5.

In an embodiment, the bonded abrasive body can have a particular a small neighboring pore count which may facilitate improved manufacturing and/or performance of the article. In an embodiment, the small neighboring pore count can be at least 3.9 or at least 4.0 or at least 4.1 or at least 4.2 or at least 4.3 or at least 4.4 or at least 4.5 or at least 4.6 or at least 4.7 or at least 4.8 or at least 4.9 or at least 5.0 or at least 5.1 or at least 5.2 or at least 5.3 or at least 5.4 or at least 5.5 or at least 5.6 or at least 5.7 or at least 5.8 or at least 5.9 or at least 6.0 or at least 6.1 or at least 6.2 or at least 6.3 or at least 6.4. In an embodiment the small neighboring pore count can be not greater than 10 or not greater than 9.5 or not greater than 9 or not greater than 8.5 or not greater than 8 or not greater than 7.5 or not greater than 7 or not greater than 6.5. It will be appreciated that the small neighboring pore count may be between any of the minimum and maximum numbers noted above, including for example, but not limited to, at least 4.0 and not greater than 6.5 or at least 4.7 and not greater than 7.

In an embodiment, the bonded abrasive body may have a particular burst speed that may facilitate improved performance of the abrasive article. In an embodiment, the burst speed can be at least 18700-D*54, where D is the diameter of the abrasive body in mm. In an embodiment, the burst speed can be not greater than 35000-D*100 min⁻¹. It will be appreciated that the burst speed can be between the minimum and maximum values listed above.

In an embodiment, the bonded abrasive body may have a particular density that may facilitate improved performance of the abrasive article. In an embodiment, the abrasive body can have a density of at least 2.05 g/cm³ or at least 2.10 g/cm³ or at least 2.15 g/cm³ or at least 2.20 g/cm³ or at least 2.25 g/cm³ or at least 2.30 g/cm³. In an embodiment, the abrasive body can have a density of no greater than 2.50 g/cm³ or no greater than 2.45 g/cm³ or no greater than 2.40 g/cm³ or no greater than 2.35 g/cm³ or no greater than 2.30 g/cm³. It will be appreciated that the density can be between any of the minimum and maximum values noted above, including, for example, but not limited to, at least 2.05 g/cm³ and not greater than 2.50 g/cm³.

In an embodiment, the bonded abrasive body can have a particular thickness that may facilitate improved performance and/or manufacturing of the abrasive article. In an embodiment, the bonded abrasive body can have a thickness of at least 4.0 mm or 4.1 mm or 4.2 mm or 4.3 mm or 4.4 mm or 4.5 mm or 4.6 mm or 4.7 mm or 4.8 mm or 4.9 mm 5.0 mm or 5.1 mm or 5.2 mm or 5.3 mm or 5.4 mm or 5.5 mm or 5.6 mm or 5.7 mm or 5.8 mm or 5.9 mm or 6.0 mm or 6.1 mm or 6.2 mm or 6.3 mm or 6.4 mm or 6.5 mm or 6.6 mm or 6.7 mm or 6.8 mm or 6.9 mm or 7.0 mm. In an embodiment, the bonded abrasive body can have a thickness of no greater than 8.0 mm or not greater than 7.9 mm or not greater than 7.8 mm or not greater than 7.7 mm or no greater than 7.6 mm or not greater than 7.5 mm or not greater than 7.4 mm or not greater than 7.3 mm or not greater than 7.2 mm or not greater than 7.1 mm or not greater than 7.0 mm or not greater than 6.9 mm or not greater than 6.8 mm or not greater than 6.7 mm or no greater than 6.6 mm or not greater than 6.5 mm or not greater than 6.4 mm or not greater than 6.3 mm or not greater than 6.2 mm or not greater than 6.1 mm or not greater than 6.0 mm or not greater than 5.9 mm or not greater than 5.8 mm or not greater than 5.7 mm or no greater than 5.6 mm or not greater than 5.5 mm or not greater than 5.4 mm or not greater than 5.3 mm or not greater than 5.2 mm or not greater than 5.1 mm or not greater than 5.0 mm. It will be appreciated that the thickness of the abrasive article can be between any of the minimum and maximum values noted above, including, for example, but not limited to, at least 4.0 mm and no greater than 7.0 mm or at least 5.0 mm and no greater than 6.3 mm.

In an embodiment, the bonded abrasive body can have a particular diameter that may facilitate improved performance and/or manufacturing of the abrasive article. In an embodiment the bonded abrasive body can have a diameter of at least 75 mm or at least 80 mm or at least 85 mm or at least 90 mm or at least 95 mm or at least 100 mm or at least 105 mm or at least 110 mm or at least 115 mm or at least 120 mm or at least 125 mm or 150 mm or at least 180 mm or at least 230 mm. In an embodiment, the bonded abrasive body can have a diameter of not greater than 275 mm or not greater than 270 mm or not greater than 265 mm or not greater than 260 mm or not greater than 255 mm or not greater than 250 mm or not greater than 245 mm or not greater than 240 mm or not greater than 235 mm or not greater than 230 mm. It will be appreciated that the diameter of the abrasive article can be between any of the minimum and maximum values noted above, including, for example, but not limited to, at least 75 mm and no greater than mm or at least 5.0 mm and no greater than 6.3 mm. In an embodiment, the bonded abrasive body can have a diameter to thickness ratio of at least diameter to thickness of at least 10:1.

In an embodiment, the abrasive article can have a particular vibration factor that may facilitate improved performance of the abrasive article. The vibration factor can be calculated by using the abrasive article to grind a steel workpiece for 20 minutes and measuring the mean number of vibrations in m/s². In an embodiment, the abrasive article can have a vibration factor of less than 8.2 m/s² or less than 8.1 m/s² or less than 8.0 m/s² or less than 7.9 m/s² or less than 7.8 m/s² or less than 7.7 m/s² or less than 7.6 m/s² or less than 7.5 m/s² or less than 7.4 m/s² or less than 7.3 m/s² or less than 7.2 m/s² or less than 7.1 m/s² or less than 7.0 m/s². In an embodiment the abrasive article can have a mean vibration factor of at least 1 m/s² or at least 2 m/s² or at least 3 m/s² or at least 3.5 m/s² or at least 4 m/s² or at least 4.5 m/s² or at least 5 m/s² or at least 5.5 m/s² or at least 6 m/s² or at least 6.5 m/s² or at least 7 m/s². It will be appreciated that the vibration factor may be between any of the minimum and maximum values noted above, including, for example, but not limited to, at least 1 m/s² and not greater than 8.2 m/s², or at 3 m/s² and not greater than 7.9 m/s².

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. An abrasive article comprising:

a bonded abrasive body having a ratio of diameter to thickness of at least 10:1 the body comprising:

secondary abrasive particles contained in a bond material, wherein the secondary abrasive particles comprise agglomerated primary abrasive particles;

wherein the abrasive article has a diameter D (mm), a mean vibration factor of no greater than 8.25 m/s², and a burst speed of at least 18700-D*54 min⁻¹.

Embodiment 2. The abrasive article of embodiment 1, wherein the ratio of large porosity to small porosity is at least 0.4 or at least 0.5 or at least 0.6 or at least 0.7 or at least 0.8 or at least 0.9 or at least 1.0 or at least 1.1 or at least 1.2 or at least 1.3 or at least 1.4 or at least 1.5 or at least 1.6 or at least 1.7 or at least 1.8 or at least 1.9 or at least 2.0 or at least 2.1 or at least 2.2 or at least 2.3 or at least 2.4 or at least 2.5 or at least 2.6 or at least 2.7 or at least 2.8 or at least 2.9 or at least 3.0 or at least 3.1 or at least 3.2 or at least 3.3 or at least 3.4 or at least 3.5 or at least 3.6 or at least 3.7 or at least 3.8 or at least 3.9 or at least 4.0.

Embodiment 3. The abrasive article of embodiment 1, wherein the ratio of large porosity to small porosity is no greater than 10 or no greater than 9 or no greater than 8 or no greater than 7 or no greater than 6 or no greater than 5.

Embodiment 4. The abrasive article of embodiment 1, wherein at least 18% of the porosity is large porosity or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40% or at least 41% or at least 42% or at least 43% or at least 44% or at least 45% or at least 46% or at least 47% or at least 48% or at least 49% or at least 50% or at least 51% or at least 52% or at least 53% or at least 54% or at least 55% or at least 56% or at least 57% or at least 58% or at least 59% of the porosity is large porosity.

Embodiment 5. The abrasive article of embodiment 1, wherein no greater than 99% of the porosity is large porosity or no greater than 98% or no greater than 95% or no greater than 90% or no greater than 85% or no greater than 80% or no greater than 75% or no greater than 70% or no greater than 65% or no greater than 60% of the porosity is large porosity.

Embodiment 6. The abrasive article of embodiment 1, wherein the bonded abrasive body comprises a large porosity distribution factor of no greater than 0.95 or no greater than 0.9 or no greater than 0.85 or no greater than 0.8 or no greater than 0.75 or no greater than 0.7 or no greater than 0.65 or no greater than 0.6 or no greater than 0.55 or no greater than 0.5 or no greater than 0.45 or no greater than 0.4 or no greater than 0.35 or no greater than 0.3 or no greater than 0.25 or no greater than 0.2.

Embodiment 7. The abrasive article of embodiment 1, wherein the bonded abrasive body comprises a large porosity distribution factor of at least 0.01 or at least 0.2 or at least 0.03 or at least 0.04 or at least 0.05 or at least 0.06 or at least 0.07 or at least 0.08 or at least 0.09 or at least 0.10 or at least 0.11 or at least 0.12 or at least 0.13 or at least 0.14 or at least 0.15.

Embodiment 8. The abrasive article of embodiment 1, wherein the bonded abrasive body comprises a porosity distribution factor of no greater than 0.35 or no greater than 0.3 or no greater than 0.25 or no greater than 0.2.

Embodiment 9. The abrasive article of embodiment 1, wherein the bonded abrasive body comprises a porosity distribution factor of at least 0.01 or at least 0.2 or at least 0.03 or at least 0.04 or at least 0.05 or at least 0.06 or at least 0.07 or at least 0.08 or at least 0.09 or at least 0.10.

Embodiment 10. The abrasive article of embodiment 1, wherein the bonded abrasive body comprises a large porosity distribution factor of no greater than 0.95 and wherein at least 18% of the porosity is large porosity.

Embodiment 11. The abrasive article of embodiment 1, wherein the bonded abrasive body comprises a burst speed of at least 18700-D*54 min⁻¹.

Embodiment 12. The abrasive article of embodiment 1, wherein the bonded abrasive body comprises a burst speed of not greater than 35000-D*100 min⁻¹.

Embodiment 13. The abrasive article of embodiment 1, wherein at least 50% of the secondary abrasive particles comprise agglomerated primary abrasive particles or at least 55% or at least 60% or at least 65% or at least 70% or at least 75% or at least 80% or at least 85% or at least 90% or at least 95% of the secondary abrasive particles comprise agglomerated primary abrasive particles, or wherein the secondary abrasive particles consist of agglomerated primary abrasive particles.

Embodiment 14. The abrasive article of embodiment 1, wherein no greater than 99% of the secondary abrasive particles comprise agglomerated primary abrasive particles or no greater than 98% or no greater than 97% or no greater than 96% or no greater than 95% or no greater than 94% or no greater than 93% or no greater than 92% or no greater than 91% or no greater than 90% or no greater than 85% or no greater than 80% or no greater than 75% or no greater than 70% of the secondary abrasive particles comprise agglomerated primary abrasive particles.

Embodiment 15. The abrasive article of embodiment 1 wherein the bonded abrasive body is free of unagglomerated abrasive particles.

Embodiment 16. The abrasive article of embodiment 1, wherein the agglomerated primary abrasive particles comprise primary abrasive particles and a binder.

Embodiment 17. The abrasive article of embodiment 16, wherein the primary abrasive particles comprise brown fused alumina.

Embodiment 18. The abrasive article of embodiment 16, wherein the primary abrasive particles comprise at least 90% Al₂O₃ or at least 91% or at least 92% or at least 93% or at least 94% or at least 95% or at least 96% or at least 97% or at least 98% Al₂O₃.

Embodiment 19. The abrasive article of embodiment 16, wherein the primary abrasive particles comprise no greater than 99.9% Al₂O₃ or no greater than 99.8% or no greater than 99.7% or no greater than 99.6% or no greater than 99.5% or no greater than 99% Al₂O₃.

Embodiment 20. The abrasive article of embodiment 16, wherein the primary abrasive particles further comprise SiO₂, Fe₂O₃, CaO, and TiO₂.

Embodiment 21. The abrasive article of embodiment 20, wherein the primary abrasive particles comprise no greater than 1.5% SiO₂.

Embodiment 22. The abrasive article of embodiment 20, wherein the primary abrasive particles comprise no greater than 0.3% Fe₂O₃.

Embodiment 23. The abrasive article of embodiment 20, wherein the primary abrasive particles comprise no greater than 0.3% CaO.

Embodiment 24. The abrasive article of embodiment 20, wherein the primary abrasive particles comprise no greater than 1.5% TiO₂.

Embodiment 25. The abrasive article of embodiment 16, wherein the primary abrasive particles have an average grit size of at least 250 microns or at least 275 microns or at least 300 microns or at least 325 microns or at least 350 microns or at least 375 microns or at least 400 microns or at least 425 microns or at least 450 microns or at least 475 microns.

Embodiment 26. The abrasive article of embodiment 16, wherein the primary abrasive particles have an average grit size of no greater than 1000 microns or no greater than 950 microns or no greater than 900 microns or no greater than 850 microns or no greater than 800 microns or no greater than 750 microns or no greater than 700 microns or no greater than 650 microns or no greater than 600 microns.

Embodiment 27. The abrasive article of embodiment 16, wherein the primary abrasive particles have a bulk density of at least 1.4 g/cm² or at least 1.41 g/cm² or at least 1.42 g/cm² or at least 1.43 g/cm² or at least 1.44 g/cm² or at least 1.45 g/cm² or at least 1.46 g/cm² or at least 1.47 g/cm² or at least 1.48 g/cm² or at least 1.49 g/cm² or at least 1.5 g/cm² or at least 1.51 g/cm² or at least 1.52 g/cm² or at least 1.53 g/cm² or at least 1.54 g/cm² or at least 1.55 g/cm² or at least 1.56 g/cm² or at least 1.57 g/cm² or at least 1.58 g/cm² or at least 1.59 g/cm² or at least 1.6 g/cm².

Embodiment 28. The abrasive article of embodiment 16, wherein the primary abrasive particles have a bulk density of no greater than 2 g/cm² or no greater than 1.99 g/cm² or no greater than 1.98 g/cm² or no greater than 1.97 g/cm² or no greater than 1.96 g/cm² or no greater than 1.95 g/cm² or no greater than 1.94 g/cm² or no greater than 1.93 g/cm² or no greater than 1.92 g/cm² or no greater than 1.91 g/cm² or no greater than 1.90 g/cm² or no greater than 1.89 g/cm² or no greater than 1.88 g/cm² or no greater than 1.87 g/cm² or no greater than 1.86 g/cm² or no greater than 1.85 g/cm² or no greater than 1.84 g/cm² or no greater than 1.83 g/cm² or no greater than 1.82 g/cm² or no greater than 1.81 g/cm² or no greater than 1.80 g/cm².

Embodiment 29. The abrasive article of embodiment 16, wherein the primary abrasive particles consist of brown fused alumina.

Embodiment 30. The abrasive article of embodiment 16, wherein the binder comprises a vitreous binder.

Embodiment 31. The abrasive article of embodiment 16, wherein the binder consists of a vitreous binder.

Embodiment 32. The abrasive article of embodiment 16, wherein the agglomerated primary abrasive particles consist of brown fused alumina and a vitreous binder system.

Embodiment 33. The abrasive article of embodiment 16, wherein the binder is a vitrified bond composition comprising SiO₂ and B₂O₃.

Embodiment 34. The abrasive article of embodiment 33, wherein the binder comprises at least 30% SiO₂ and B₂O₃ or at least 31% or at least 32% or at least 33% or at least 34% or at least 35% or at least 36% or at least 37% or at least 38% or at least 39% or at least 40% or at least 41% or at least 42% or at least 43% or at least 44% or at least 45% or at least 46% or at least 47% or at least 48% or at least 49% or at least 50% or at least 51% or at least 52% or at least 53% or at least 54% or at least 55% or at least 56% or at least 57% or at least 58% or at least 59% or at least 60% SiO₂ and B₂O₃.

Embodiment 35. The abrasive article of embodiment 33, wherein the binder comprises no greater than 99% SiO₂ and B₂O₃ or no greater than 98% or no greater than 95% or no greater than 90% or no greater than 85% or no greater than 80% or no greater than 75% or no greater than 70% SiO₂ and B₂O₃.

Embodiment 36. The abrasive article of embodiment 33, wherein the binder further comprises Al₂O₃.

Embodiment 37. The abrasive article of embodiment 36, wherein the binder comprises at least 1% Al₂O₃ or at least 2% or at least 3% or at least 4% or at least 5% or at least 6% or at least 7% or at least 8% or at least 9% or at least 10% or at least 11% or at least 12% or at least 13% or at least 14% Al₂O₃.

Embodiment 38. The abrasive article of embodiment 36, wherein the binder comprises no greater than 40% Al₂O₃ or no greater than 35% or no greater than 30% or no greater than 25% or no greater than 20% Al₂O₃.

Embodiment 39. The abrasive article of embodiment 33, wherein the binder further comprises alkali oxides.

Embodiment 40. The abrasive article of embodiment 39, wherein the binder comprises at least or at least 1% alkali oxides or at least 2% or at least 3% or at least 4% or at least 5% or at least 6% or at least 7% or at least 8% or at least 9% or at least 10% or at least 11% or at least 12% or at least 13% or at least 14% alkali oxides.

Embodiment 41. The abrasive article of embodiment 39, wherein the binder comprises no greater than 40% alkali oxides or no greater than 35% or no greater than 30% or no greater than 25% or no greater than 20% alkali oxides.

Embodiment 42. The abrasive article of embodiment 33, wherein the binder further comprises alkali Earth oxides.

Embodiment 43. The abrasive article of embodiment 42, wherein the binder comprises no greater than 1 wt % alkali Earth oxides.

Embodiment 44. The abrasive article of embodiment 16, wherein the binder is a ceramic material selected from silica, alkali, alkaline-earth, mixed alkali and alkaline-earth silicates, aluminum silicates, zirconium silicates, hydrated silicates, aluminates, oxides, nitrides, oxynitrides, carbides, oxycarbides and combinations and derivatives thereof.

Embodiment 45. The abrasive article of embodiment 16, wherein the melting temperature of the binder is 800° C.

to 1300° C.

Embodiment 46. The abrasive article of embodiment 16, wherein the melting temperature of the binder is at least 500° C. or at least 550° C. or at least 600° C. or at least 650° C. or at least 700° C. or at least 750° C. or at least 800° C.

Embodiment 47. The abrasive article of embodiment 16, wherein the melting temperature of the binder is no greater than 1600° C. or no greater than 1550° C. or no greater than 1500° C. or no greater than 1450° C. or no greater than 1400° C. or no greater than 1350° C. or no greater than 1300° C.

Embodiment 48. The abrasive article of embodiment 16, wherein the secondary abrasive particles have an average size of 2 times the average size of the primary abrasive particles or at least 3 times or at least 4 times or at least 5 times or at least 6 times or at least 7 times or at least 8 times or at least 9 times or at least 10 times or at least 11 times or at least 12 times or at least 13 times or at least 14 times or at least 15 times or at least 16 times or at least 17 times or at least 18 times or at least 19 times or at least 20 times the average size of the primary abrasive particles.

Embodiment 49. The abrasive article of embodiment 1, wherein the bond material comprises an organic bond material.

Embodiment 50. The abrasive article of embodiment 1, wherein the bond material consists of an organic bond material.

Embodiment 51. The abrasive article of embodiment 1, wherein the bonded abrasive body comprises closed porosity.

Embodiment 52. The abrasive article of embodiment 1, wherein the bonded abrasive body comprises interconnected porosity.

Embodiment 53. The abrasive article of embodiment 1, wherein the bonded abrasive body comprises interconnected porosity and closed porosity.

Embodiment 54. The abrasive article of embodiment 1, wherein a majority of the porosity within the body is closed porosity.

Embodiment 55. The abrasive article of embodiment 1, wherein the bonded abrasive body does not include pore-forming materials.

Embodiment 56. The abrasive article of embodiment 1, wherein the bonded abrasive body comprises at least 10 vol % bond material for a total volume of the bonded abrasive body or at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % or at least 31 vol % or at least 32 vol % or at least 33 vol % or at least 34 vol % or at least 35 vol % or at least 36 vol % or at least 37 vol % or at least 38 vol % or at least 39 vol % or at least 40 vol % bond material for a total volume of the bonded abrasive body.

Embodiment 57. The abrasive article of embodiment 1, wherein the bonded abrasive body comprises not greater than 55 vol % bond material for a total volume of the bonded abrasive body or not greater than 54 vol % or not greater than 53 vol % or not greater than 52 vol % or not greater than 51 vol % or not greater than 50 vol % or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % bond material for a total volume of the bonded abrasive body.

Embodiment 58. The abrasive article of embodiment 1, wherein the bonded abrasive body comprises at least 10 vol % porosity for a total volume of the bonded abrasive body or at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % porosity for a total volume of the bonded abrasive body.

Embodiment 59. The abrasive article of embodiment 1, wherein the bonded abrasive body comprises not greater than 50 vol % porosity for a total volume of the bonded abrasive body or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % or not greater than 29 vol % or not greater than 28 vol % or not greater than 27 vol % or not greater than 26 vol % or not greater than 25 vol % or not greater than 24 vol % or not greater than 23 vol % or not greater than 22 vol % or not greater than 21 vol % or not greater than 20 vol % porosity for a total volume of the bonded abrasive body.

Embodiment 60. The abrasive article of embodiment 1, wherein the bonded abrasive body comprises at least 10 vol % abrasive particles for a total volume of the bonded abrasive body or at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % abrasive particles for a total volume of the bonded abrasive body.

Embodiment 61. The abrasive article of embodiment 1, wherein the bonded abrasive body comprises not greater than 50 vol % abrasive particles for a total volume of the bonded abrasive body or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % abrasive particles for a total volume of the bonded abrasive body.

Embodiment 62. The abrasive article of embodiment 1, wherein the bonded abrasive body comprises least 10 vol % agglomerated primary abrasive particles for a total volume of the bonded abrasive body or at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % agglomerated primary abrasive particles for a total volume of the bonded abrasive body.

Embodiment 63. The abrasive article of embodiment 1, wherein the bonded abrasive body comprises not greater than 50 vol % agglomerated primary abrasive particles for a total volume of the bonded abrasive body or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % agglomerated primary abrasive particles for a total volume of the bonded abrasive body.

Embodiment 64. The abrasive article of embodiment 1, wherein the bonded abrasive body has a density of at least

2.05 g/cm³ or at least 2.10 g/cm³ or at least 2.15 g/cm³ or at least 2.20 g/cm³ or at least 2.25 g/cm³ or at least 2.30 g/cm³.

Embodiment 65. The abrasive article of embodiment 1, wherein the bonded abrasive body has a density of no greater than 2.50 g/cm³ or no greater than 2.45 g/cm³ or no greater than 2.40 g/cm³ or no greater than 2.35 g/cm³ or no greater than 2.30 g/cm³.

Embodiment 66. The abrasive article of embodiment 1, wherein the bonded abrasive body has a thickness of at least 4.0 mm or 4.1 mm or 4.2 mm or 4.3 mm or 4.4 mm or 4.5 mm or 4.6 mm or 4.7 mm or 4.8 mm or 4.9 mm 5.0 mm or 5.1 mm or 5.2 mm or 5.3 mm or 5.4 mm or 5.5 mm or 5.6 mm or 5.7 mm or 5.8 mm or 5.9 mm or 6.0 mm or 6.1 mm or 6.2 mm or 6.3 mm or 6.4 mm or 6.5 mm or 6.6 mm or 6.7 mm or 6.8 mm or 6.9 mm or 7.0 mm.

Embodiment 67. The abrasive article of embodiment 1, wherein the bonded abrasive body has a thickness of not greater than 8.0 mm or not greater than 7.9 mm or not greater than 7.8 mm or not greater than 7.7 mm or no greater than 7.6 mm or not greater than 7.5 mm or not greater than 7.4 mm or not greater than 7.3 mm or not greater than 7.2 mm or not greater than 7.1 mm or not greater than 7.0 mm or not greater than 6.9 mm or not greater than 6.8 mm or not greater than 6.7 mm or no greater than 6.6 mm or not greater than 6.5 mm or not greater than 6.4 mm or not greater than 6.3 mm or not greater than 6.2 mm or not greater than 6.1 mm or not greater than 6.0 mm or not greater than 5.9 mm or not greater than 5.8 mm or not greater than 5.7 mm or no greater than 5.6 mm or not greater than 5.5 mm or not greater than 5.4 mm or not greater than 5.3 mm or not greater than 5.2 mm or not greater than 5.1 mm or not greater than 5.0 mm.

Embodiment 68. The abrasive article of embodiment 1, wherein the bonded abrasive body has a diameter of at least 75 mm or at least 80 mm or at least 85 mm or at least 90 mm or at least 95 mm or at least 100 mm or at least 105 mm or at least 110 mm or at least 115 mm or at least 120 mm or at least 125 mm or 150 mm or at least 180 mm or at least 230 mm.

Embodiment 69. The abrasive article of embodiment 1, wherein the bonded abrasive body has a diameter of not greater than 275 mm or not greater than 270 mm or not greater than 265 mm or not greater than 260 mm or not greater than 255 mm or not greater than 250 mm or not greater than 245 mm or not greater than 240 mm or not greater than 235 mm or not greater than 230 mm.

Embodiment 70. The abrasive article of embodiment 1, having a vibration factor of less than 8.2 m/s² or less than 8.1 m/s² or less than 8.0 m/s² or less than 7.9 m/s² or less than 7.8 m/s² or less than 7.7 m/s² or less than 7.6 m/s² or less than 7.5 m/s² or less than 7.4 m/s² or less than 7.3 m/s² or less than 7.2 m/s² or less than 7.1 m/s² or less than 7.0 m/s².

Embodiment 71. The abrasive article of embodiment 1, having a vibration factor of at least 1 m/s² or at least 2 m/s² or at least 3 m/s² or at least 3.5 m/s² or at least 4 m/s² or at least 4.5 m/s² or at least 5 m/s² or at least 5.5 m/s² or at least 6 m/s² or at least 6.5 m/s² or at least 7 m/s².

Embodiment 72. The abrasive article of embodiment 1, wherein the bonded abrasive body comprises a mean pore spacing distance of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 73. The abrasive article of embodiment 1, wherein the bonded abrasive body comprises a mean pore spacing distance of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 74. The abrasive article of embodiment 1, wherein the bonded abrasive body comprises a pore spacing distance standard deviation of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 75. The abrasive article of embodiment 1, wherein the bonded abrasive body comprises a pore spacing distance standard deviation of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 76. The abrasive article of embodiment 1, wherein the bonded abrasive body comprises PS10 of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 77. The abrasive article of embodiment 1, wherein the bonded abrasive body comprises a PS10 of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 78. The abrasive article of embodiment 1, wherein the bonded abrasive body comprises PS25 of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 79. The abrasive article of embodiment 1, wherein the bonded abrasive body comprises a PS25 of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 80. The abrasive article of embodiment 1, wherein the bonded abrasive body comprises PS50 of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 81. The abrasive article of embodiment 1, wherein the bonded abrasive body comprises a PS50 of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 82. The abrasive article of embodiment 1, wherein the bonded abrasive body comprises PS75 of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 83. The abrasive article of embodiment 1, wherein the bonded abrasive body comprises a PS75 of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 84. The abrasive article of embodiment 1, wherein the bonded abrasive body comprises PS90 of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 85. The abrasive article of embodiment 1, wherein the bonded abrasive body comprises a PS90 of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 86. The abrasive article of embodiment 1, wherein the bonded abrasive body comprises an average neighboring pore count of at least 5.25 or at least 5.5 or at least 5.75 or at least 6 or at least 6.25 or at least 6.5 or at least 6.75 or at least 7 or at least 7.25 or at least 7.5 or at least 7.75 or at least 8 or at least 8.25 or at least 8.5 or at least 8.75 or at least 9.

Embodiment 87. The abrasive article of embodiment 1, wherein the bonded abrasive body comprises an average neighboring pore count of not greater than 20 not greater than or 19 not greater than 18 or not greater than 17 or not greater than 16 or not greater than 15 or not greater than 14 or not greater than 13 or not greater than 12 or not greater than 11 or not greater than 10.

Embodiment 88. The abrasive article of embodiment 1, wherein the bonded abrasive body comprises a large neighboring pore count of at least 0.05 or at least 0.1 or at least 0.15 or at least 0.2 or at least 0.25 or at least 0.3 or at least 0.35 or at least 0.4 or at least 0.45 or at least 0.5 or at least 0.55.

Embodiment 89. The abrasive article of embodiment 1, wherein the bonded abrasive body comprises a large neighboring pore count of not greater than 2 or not greater than 1.9 or not greater than 1.8 or not greater than 1.7 or not greater than 1.6 or not greater than 1.5 or not greater than 1.4 or not greater than 1.3 or not greater than 1.2 or not greater than 1.1 or not greater than 1.0 or not greater than 0.9 or not greater than 0.8 or not greater than 0.7 or not greater than 0.6.

Embodiment 90. The abrasive article of embodiment 1, wherein the bonded abrasive body comprises a medium neighboring pore count of at least 1.4 or at least 1.5 or at least 1.6 or at least 1.7 or at least 1.8 or at least 1.9 or at least 2.0 or at least 2.1 or at least 2.2 or at least 2.3 or at least 2.4 or at least 2.5 or at least 2.6 or at least 2.7 or at least 2.8 or at least 2.9.

Embodiment 91. The abrasive article of embodiment 1, wherein the bonded abrasive body comprises a medium neighboring pore count of not greater than 5 or not greater than 4.75 or not greater than 4.5 or not greater than 4.25 or not greater than 4 or not greater than 3.75 or not greater than 3.5 or not greater than 3.25 or not greater than 3.

Embodiment 92. The abrasive article of embodiment 1, wherein the bonded abrasive body comprises a small neighboring pore count of at least 3.9 or at least 4.0 or at least 4.1 or at least 4.2 or at least 4.3 or at least 4.4 or at least 4.5 or at least 4.6 or at least 4.7 or at least 4.8 or at least 4.9 or at least 5.0 or at least 5.1 or at least 5.2 or at least 5.3 or at least 5.4 or at least 5.5 or at least 5.6 or at least 5.7 or at least 5.8 or at least 5.9 or at least 6.0 or at least 6.1 or at least 6.2 or at least 6.3 or at least 6.4.

Embodiment 93. The abrasive article of embodiment 1, wherein the bonded abrasive body comprises a medium neighboring pore count of not greater than 10 or not greater than 9.5 or not greater than 9 or not greater than 8.5 or not greater than 8 or not greater than 7.5 or not greater than 7 or not greater than 6.5.

Embodiment 94. A method of making a bonded abrasive body having a ratio of diameter to thickness of at least 10:1 the body comprising:

secondary abrasive particles contained in a bond material, wherein the secondary abrasive particles comprise agglomerated primary abrasive particles;

wherein the abrasive article has a mean vibration factor of no greater than 8.25 m/s² and a burst speed of at least 35000-D*100 min⁻¹.

Embodiment 95. The method of embodiment 94, further comprising providing a mixture that includes agglomerated primary abrasive particles and bond material.

Embodiment 96. The method of embodiment 95, wherein the mixture comprises at least 25 vol % agglomerated primary abrasive particles for a total volume of the mixture at least 26 vol % or at least 27 vol % or at least 28 vol % or at least 29 vol % or at least 30 vol % or at least 31 vol % or at least 32 vol % or at least 33 vol % or at least 34 vol % or at least 35 vol % or at least 36 vol % or at least 37 vol % or at least 38 vol % or at least 39 vol % or at least 40 vol % or at least 41 vol % or at least 42 vol % or at least 43 vol % or at least 44 vol % or at least 45 vol % or at least 46 vol % or at least 47 vol % or at least 48 vol % or at least 49 vol % or at least 50 vol % or at least 51 vol % or at least 52 vol % or at least 53 vol % or at least 54 vol % or at least 55 vol % or at least 56 vol % or at least 57 vol % or at least 58 vol % or at least 59 vol % or at least 60 vol % or at least 61 vol % or at least 62 vol % or at least 63 vol % or at least 64 vol % or at least 65 vol % or at least 66 vol % or at least 67 vol % or at least 68 vol % or at least 69 vol % or at least 70 vol % or at least 71 vol % or at least 72 vol % or at least 73 vol % or at least 74 vol % or at least 75 vol % or at least 76 vol % or at least 77 vol % or at least 78 vol % or at least 79 vol % agglomerated primary abrasive particles for a total volume of the mixture.

Embodiment 97. The method of embodiment 95, wherein the mixture comprises no greater than 80 vol % agglomerated primary abrasive particles for a total volume of the mixture, or no greater than or not greater than 79 vol % or not greater than 78 vol % or not greater than 77 vol % or not greater than 76 vol % or not greater than 75 vol % or not greater than 74 vol % or not greater than 73 vol % or not greater than 72 vol % or not greater than 71 vol % or not greater than 70 vol % or not greater than 69 vol % or not greater than 68 vol % or not greater than 67 vol % or not greater than 66 vol % or not greater than 65 vol % or not greater than 64 vol % or not greater than 63 vol % or not greater than 62 vol % or not greater than 61 vol % or not greater than 60 vol % or not greater than 59 vol % or not greater than 58 vol % or not greater than 57 vol % or not greater than 56 vol % or not greater than 55 vol % or not greater than 54 vol % or not greater than 53 vol % or not greater than 52 vol % or not greater than 51 vol % or not greater than 50 vol % or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % agglomerated primary abrasive particles for a total volume of the mixture.

Embodiment 98. The method of embodiment 95, wherein the mixture comprises at least 25 vol % binder for a total volume of the mixture at least 26 vol % or at least 27 vol % or at least 28 vol % or at least 29 vol % or at least 30 vol % or at least 31 vol % or at least 32 vol % or at least 33 vol % or at least 34 vol % or at least 35 vol % or at least 36 vol % or at least 37 vol % or at least 38 vol % or at least 39 vol % or at least 40 vol % or at least 41 vol % or at least 42 vol % or at least 43 vol % or at least 44 vol % or at least 45 vol % or at least 46 vol % or at least 47 vol % or at least 48 vol % or at least 49 vol % or at least 50 vol % or at least 51 vol % or at least 52 vol % or at least 53 vol % or at least 54 vol % or at least 55 vol % or at least 56 vol % or at least 57 vol % or at least 58 vol % or at least 59 vol % or at least 60 vol % or at least 61 vol % or at least 62 vol % or at least 63 vol % or at least 64 vol % or at least 65 vol % or at least 66 vol % or at least 67 vol % or at least 68 vol % or at least 69 vol % or at least 70 vol % or at least 71 vol % or at least 72 vol % or at least 73 vol % or at least 74 vol % or at least 75 vol % or at least 76 vol % or at least 77 vol % or at least 78 vol % or at least 79 vol % binder for a total volume of the mixture.

Embodiment 99. The method of embodiment 95, wherein the mixture comprises no greater than 80 vol % binder for a total volume of the mixture, or no greater than or not greater than 79 vol % or not greater than 78 vol % or not greater than 77 vol % or not greater than 76 vol % or not greater than 75 vol % or not greater than 74 vol % or not greater than 73 vol % or not greater than 72 vol % or not greater than 71 vol % or not greater than 70 vol % or not greater than 69 vol % or not greater than 68 vol % or not greater than 67 vol % or not greater than 66 vol % or not greater than 65 vol % or not greater than 64 vol % or not greater than 63 vol % or not greater than 62 vol % or not greater than 61 vol % or not greater than 60 vol % or not greater than 59 vol % or not greater than 58 vol % or not greater than 57 vol % or not greater than 56 vol % or not greater than 55 vol % or not greater than 54 vol % or not greater than 53 vol % or not greater than 52 vol % or not greater than 51 vol % or not greater than 50 vol % or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % binder for a total volume of the mixture.

Embodiment 100. The method of embodiment 95, further comprising pressing the mixture into a green abrasive body.

Embodiment 101. The method of embodiment 100, wherein the mixture is pressed with a pressure of at least 30 bar or at least 31 bar or at least 32 bar or at least 33 bar or at least 34 bar or at least 35 bar or at least 36 bar or at least 37 bar or at least 38 bar or at least 39 bar or at least 40 bar or at least 41 bar or at least 42 bar or at least 43 bar or at least 44 bar or at least 45 bar or at least 46 bar or at least 47 bar or at least 48 bar or at least 50 bar.

Embodiment 102. The method of embodiment 100, wherein the mixture is pressed with a pressure of no greater than 275 bar or no greater than 270 bar or no greater than 265 bar or no greater than 260 bar or no greater than 255 bar or no greater than 250 bar or no greater than 245 bar or no greater than 240 bar or no greater than 235 bar or no greater than 230 bar or no greater than 225 bar or no greater than 220 bar or no greater than 215 bar or no greater than 210 bar or no greater than 205 bar or no greater than 200 bar or no greater than 195 bar or no greater than 190 bar or no greater than 185 bar or no greater than 180 bar or no greater than 175 bar or no greater than 170 bar or no greater than 165 bar or no greater than 160 bar or no greater than 155 bar or no greater than 150 bar or no greater than 145 bar or no greater than 140 bar or no greater than 135 bar or no greater than 130 bar or no greater than 125 bar.

Embodiment 103. The method of embodiment 100, wherein the green abrasive body is cured at a temperature of at least 150° C. or at least 152° C. or at least 154° C. or at least 156° C. or at least 158° C. or at least 160° C. or at least 161° C. or at least 162° C. or at least 163° C. at least 164° C. or at least 165° C. or at least 166° C. or at least 167° C. or at least 168° C. or at least 169° C. or at least 170° C.

Embodiment 104. The method of embodiment 100, wherein the green abrasive body is cured at a temperature of not greater than 225° C. or no greater than 220° C. or no greater than 215° C. or no greater than 210° C. or no greater than 205° C. or no greater than 200° C. or no greater than 195° C. or no greater than 190° C. or no greater than 185° C. or no greater than 180° C. or no greater than 175° C.

Embodiment 105. The method of embodiment 94, wherein the bonded abrasive body comprises ratio of large porosity to small porosity is at least 0.4 or at least 0.5 or at least 0.6 or at least 0.7 or at least 0.8 or at least 0.9 or at least 1.0 or at least 1.1 or at least 1.2 or at least 1.3 or at least 1.4 or at least 1.5 or at least 1.6 or at least 1.7 or at least 1.8 or at least 1.9 or at least 2.0 or at least 2.1 or at least 2.2 or at least 2.3 or at least 2.4 or at least 2.5 or at least 2.6 or at least 2.7 or at least 2.8 or at least 2.9 or at least 3.0 or at least 3.1 or at least 3.2 or at least 3.3 or at least 3.4 or at least 3.5 or at least 3.6 or at least 3.7 or at least 3.8 or at least 3.9 or at least 4.0.

Embodiment 106. The method of embodiment 94, wherein the bonded abrasive body comprises ratio of large porosity to small porosity is no greater than 10 or no greater than 9 or no greater than 8 or no greater than 7 or no greater than 6 or no greater than 5.

Embodiment 107. The method of embodiment 94, wherein at least 18% of the porosity of the boded abrasive body is large porosity or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40% or at least 41% or at least 42% or at least 43% or at least 44% or at least 45% or at least 46% or at least 47% or at least 48% or at least 49% or at least 50% or at least 51% or at least 52% or at least 53% or at least 54% or at least 55% or at least 56% or at least 57% or at least 58% or at least 59% of the porosity is large porosity.

Embodiment 108. The method of embodiment 94, wherein no greater than 99% of the porosity is large porosity or no greater than 98% or no greater than 95% or no greater than 90% or no greater than 85% or no greater than 80% or no greater than 75% or no greater than 70% or no greater than 65% or no greater than 60% of the porosity is large porosity.

Embodiment 109. The method of embodiment 94, wherein the bonded abrasive body comprises a large porosity distribution factor of no greater than 0.95 or no greater than 0.9 or no greater than 0.85 or no greater than 0.8 or no greater than 0.75 or no greater than 0.7 or no greater than 0.65 or no greater than 0.6 or no greater than 0.55 or no greater than 0.5 or no greater than 0.45 or no greater than 0.4 or no greater than 0.35 or no greater than 0.3 or no greater than 0.25 or no greater than 0.2.

Embodiment 110. The method of embodiment 94, wherein the bonded abrasive body comprises a large porosity distribution factor of at least 0.01 or at least 0.2 or at least 0.03 or at least 0.04 or at least 0.05 or at least 0.06 or at least 0.07 or at least 0.08 or at least 0.09 or at least 0.10 or at least 0.11 or at least 0.12 or at least 0.13 or at least 0.14 or at least 0.15.

Embodiment 111. The method of embodiment 94, wherein the bonded abrasive body comprises a porosity distribution factor of no greater than 0.35 or no greater than 0.3 or no greater than 0.25 or no greater than 0.2.

Embodiment 112. The method of embodiment 94, wherein the bonded abrasive body comprises a porosity distribution factor of at least 0.01 or at least 0.2 or at least 0.03 or at least 0.04 or at least 0.05 or at least 0.06 or at least 0.07 or at least 0.08 or at least 0.09 or at least 0.10.

Embodiment 113. The method of embodiment 94, wherein the bonded abrasive body comprises a large porosity distribution factor of no greater than 0.95 and wherein at least 18% of the porosity is large porosity.

Embodiment 114. The method of embodiment 94, wherein the bonded abrasive body comprises a burst speed of at least 18700-D*54 min⁻¹.

Embodiment 115. The method of embodiment 94, wherein the bonded abrasive body comprises a burst speed of not greater than 35000-D*100 min⁻¹.

Embodiment 116. The method of embodiment 94, wherein at least 50% of the secondary abrasive particles comprise agglomerated primary abrasive particles or at least 55% or at least 60% or at least 65% or at least 70% or at least 75% or at least 80% or at least 85% or at least 90% or at least 95% of the secondary abrasive particles comprise agglomerated primary abrasive particles, or wherein the secondary abrasive particles consist of agglomerated primary abrasive particles.

Embodiment 117. The method of embodiment 94, wherein no greater than 99% of the secondary abrasive particles comprise agglomerated primary abrasive particles or no greater than 98% or no greater than 97% or no greater than 96% or no greater than 95% or no greater than 94% or no greater than 93% or no greater than 92% or no greater than 91% or no greater than 90% or no greater than 85% or no greater than 80% or no greater than 75% or no greater than 70% of the secondary abrasive particles comprise agglomerated primary abrasive particles.

Embodiment 118. The method of embodiment 94, wherein the bonded abrasive body is free of unagglomerated abrasive particles.

Embodiment 119. The method of embodiment 94, wherein the agglomerated primary abrasive particles comprise primary abrasive particles and a binder.

Embodiment 120. The method of embodiment 119, wherein the primary abrasive particles comprise brown fused alumina.

Embodiment 121. The method of embodiment 119, wherein the primary abrasive particles comprise at least 90% Al₂O₃ or at least 91% or at least 92% or at least 93% or at least 94% or at least 95% or at least 96% or at least 97% or at least 98% Al₂O₃.

Embodiment 122. The method of embodiment 119, wherein the primary abrasive particles comprise no greater than 99.9% Al₂O₃ or no greater than 99.8% or no greater than 99.7% or no greater than 99.6% or no greater than 99.5% or no greater than 99% Al₂O₃.

Embodiment 123. The method of embodiment 119, wherein the primary abrasive particles further comprise SiO₂, Fe₂O₃, CaO, and TiO₂.

Embodiment 124. The method of embodiment 123, wherein the primary abrasive particles comprise no greater than 1.5% SiO₂.

Embodiment 125. The method of embodiment 123, wherein the primary abrasive particles comprise no greater than 0.3% Fe₂O₃.

Embodiment 126. The method of embodiment 123, wherein the primary abrasive particles comprise no greater than 0.3% CaO.

Embodiment 127. The method of embodiment 123, wherein the primary abrasive particles comprise no greater than 1.5% TiO₂.

Embodiment 128. The method of embodiment 119, wherein the primary abrasive particles have an average grit size of at least 250 microns or at least 275 microns or at least 300 microns or at least 325 microns or at least 350 microns or at least 375 microns or at least 400 microns or at least 425 microns or at least 450 microns or at least 475 microns.

Embodiment 129. The method of embodiment 119, wherein the primary abrasive particles have an average grit size of no greater than 1000 microns or no greater than 950 microns or no greater than 900 microns or no greater than 850 microns or no greater than 800 microns or no greater than 750 microns or no greater than 700 microns or no greater than 650 microns or no greater than 600 microns.

Embodiment 130. The method of embodiment 119, wherein the primary abrasive particles have a bulk density of at least 1.4 g/cm² or at least 1.41 g/cm² or at least 1.42 g/cm² or at least 1.43 g/cm² or at least 1.44 g/cm² or at least 1.45 g/cm² or at least 1.46 g/cm² or at least 1.47 g/cm² or at least 1.48 g/cm² or at least 1.49 g/cm² or at least 1.5 g/cm² or at least 1.51 g/cm² or at least 1.52 g/cm² or at least 1.53 g/cm² or at least 1.54 g/cm² or at least 1.55 g/cm² or at least 1.56 g/cm² or at least 1.57 g/cm² or at least 1.58 g/cm² or at least 1.59 g/cm² or at least 1.6 g/cm².

Embodiment 131. The method of embodiment 119, wherein the primary abrasive particles have a bulk density of no greater than 2 g/cm² or no greater than 1.99 g/cm² or no greater than 1.98 g/cm² or no greater than 1.97 g/cm² or no greater than 1.96 g/cm² or no greater than 1.95 g/cm² or no greater than 1.94 g/cm² or no greater than 1.93 g/cm² or no greater than 1.92 g/cm² or no greater than 1.91 g/cm² or no greater than 1.90 g/cm² or no greater than 1.89 g/cm² or no greater than 1.88 g/cm² or no greater than 1.87 g/cm² or no greater than 1.86 g/cm² or no greater than 1.85 g/cm² or no greater than 1.84 g/cm² or no greater than 1.83 g/cm² or no greater than 1.82 g/cm² or no greater than 1.81 g/cm² or no greater than 1.80 g/cm².

Embodiment 132. The method of embodiment 119, wherein the primary abrasive particles consist of brown fused alumina.

Embodiment 133. The method of embodiment 119, wherein the binder comprises a vitreous binder.

Embodiment 134. The method of embodiment 119, wherein the binder consists of a vitreous binder.

Embodiment 135. The method of embodiment 119, wherein the agglomerated primary abrasive particles consist of brown fused alumina and a vitreous binder system.

Embodiment 136. The method of embodiment 119, wherein the binder is a vitrified bond composition comprising SiO₂ and B₂O₃.

Embodiment 137. The method of embodiment 136, wherein the binder comprises at least 30% SiO₂ and B₂O₃ or at least 31% or at least 32% or at least 33% or at least 34% or at least 35% or at least 36% or at least 37% or at least 38% or at least 39% or at least 40% or at least 41% or at least 42% or at least 43% or at least 44% or at least 45% or at least 46% or at least 47% or at least 48% or at least 49% or at least 50% or at least 51% or at least 52% or at least 53% or at least 54% or at least 55% or at least 56% or at least 57% or at least 58% or at least 59% or at least 60% SiO₂ and B₂O₃.

Embodiment 138. The method of embodiment 136, wherein the binder comprises no greater than 99% SiO₂ and B₂O₃ or no greater than 98% or no greater than 95% or no greater than 90% or no greater than 85% or no greater than 80% or no greater than 75% or no greater than 70% SiO₂ and B₂O₃.

Embodiment 139. The method of embodiment 136, wherein the binder further comprises Al₂O₃.

Embodiment 140. The method of embodiment 139, wherein the binder comprises at least or at least 1% Al₂O₃ or at least 2% or at least 3% or at least 4% or at least 5% or at least 6% or at least 7% or at least 8% or at least 9% or at least 10% or at least 11% or at least 12% or at least 13% or at least 14% Al₂O₃.

Embodiment 141. The method of embodiment 139, wherein the binder comprises no greater than 40% Al₂O₃ or no greater than 35% or no greater than 30% or no greater than 25% or no greater than 20% Al₂O₃.

Embodiment 142. The method of embodiment 136, wherein the binder further comprises alkali oxides.

Embodiment 143. The method of embodiment 142, wherein the binder comprises at least or at least 1% alkali oxides or at least 2% or at least 3% or at least 4% or at least 5% or at least 6% or at least 7% or at least 8% or at least 9% or at least 10% or at least 11% or at least 12% or at least 13% or at least 14% alkali oxides.

Embodiment 144. The method of embodiment 142, wherein the binder comprises no greater than 40% alkali oxides or no greater than 35% or no greater than 30% or no greater than 25% or no greater than 20% alkali oxides.

Embodiment 145. The method of embodiment 136, wherein the binder further comprises alkaline Earth oxides.

Embodiment 146. The method of embodiment 145, wherein the binder comprises no greater than 1 wt % alkaline Earth oxides.

Embodiment 147. The method of embodiment 119, wherein the binder is a ceramic material selected from silica, alkali, alkaline-earth, mixed alkali and alkaline-earth silicates, aluminum silicates, zirconium silicates, hydrated silicates, aluminates, oxides, nitrides, oxynitrides, carbides, oxycarbides and combinations and derivatives thereof.

Embodiment 148. The method of embodiment 119, wherein the melting temperature of the binder is 800° C. to 1300° C.

Embodiment 149. The method of embodiment 119, wherein the melting temperature of the binder is at least 500° C. or at least 550° C. or at least 600° C. or at least 650° C. or at least 700° C. or at least 750° C. or at least 800° C.

Embodiment 150. The method of embodiment 119, wherein the melting temperature of the binder is no greater than 1600° C. or no greater than 1550° C. or no greater than 1500° C. or no greater than 1450° C. or no greater than 1400° C. or no greater than 1350° C. or no greater than 1300° C.

Embodiment 151. The method of embodiment 119, wherein the agglomerated primary abrasive particles have an average size of 2-20 times the average size of the primary abrasive particles that has the loose pack density lower by 10% or by 15% or by 20% or by 25% than the loose pack density of the unagglomerated grains.

Embodiment 152. The method of embodiment 94, wherein the bond material comprises an organic bond material.

Embodiment 153. The method of embodiment 94, wherein the bond material consists of an organic bond material.

Embodiment 154. The method of embodiment 94, wherein the bonded abrasive body comprises closed porosity.

Embodiment 155. The method of embodiment 94, wherein the bonded abrasive body comprises interconnected porosity.

Embodiment 156. The method of embodiment 94, wherein the bonded abrasive body comprises interconnected porosity and closed porosity.

Embodiment 157. The method of embodiment 94, wherein a majority of the porosity within the body is closed porosity.

Embodiment 158. The method of embodiment 94, wherein the bonded abrasive body does not include pore-forming materials.

Embodiment 159. The method of embodiment 94, wherein the bonded abrasive body comprises at least 10 vol % bond material for a total volume of the bonded abrasive body or at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % or at least 31 vol % or at least 32 vol % or at least 33 vol % or at least 34 vol % or at least 35 vol % or at least 36 vol % or at least 37 vol % or at least 38 vol % or at least 39 vol % or at least 40 vol % bond material for a total volume of the bonded abrasive body.

Embodiment 160. The method of embodiment 94, wherein the bonded abrasive body comprises not greater than 55 vol % bond material for a total volume of the bonded abrasive body or not greater than 54 vol % or not greater than 53 vol % or not greater than 52 vol % or not greater than 51 vol % or not greater than 50 vol % or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % bond material for a total volume of the bonded abrasive body.

Embodiment 161. The method of embodiment 94, wherein the bonded abrasive body comprises at least 10 vol % porosity for a total volume of the bonded abrasive body or at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % porosity for a total volume of the bonded abrasive body.

Embodiment 162. The method of embodiment 94, wherein the bonded abrasive body comprises not greater than 50 vol % porosity for a total volume of the bonded abrasive body or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % or not greater than 29 vol % or not greater than 28 vol % or not greater than 27 vol % or not greater than 26 vol % or not greater than 25 vol % or not greater than 24 vol % or not greater than 23 vol % or not greater than 22 vol % or not greater than 21 vol % or not greater than 20 vol % porosity for a total volume of the bonded abrasive body.

Embodiment 163. The method of embodiment 94, wherein the bonded abrasive body comprises at least 10 vol % abrasive particles for a total volume of the bonded abrasive body or at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % abrasive particles for a total volume of the bonded abrasive body.

Embodiment 164. The method of embodiment 94, wherein the bonded abrasive body comprises not greater than 50 vol % abrasive particles for a total volume of the bonded abrasive body or not greater than 49 vol % or not greater than 48 vol % or not greater than 47 vol % or not greater than 46 vol % or not greater than 45 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % abrasive particles for a total volume of the bonded abrasive body.

Embodiment 165. The method of embodiment 94, wherein the bonded abrasive body comprises least 10 vol % agglomerated primary abrasive particles for a total volume of the bonded abrasive body or at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % agglomerated primary abrasive particles for a total volume of the bonded abrasive body.

Embodiment 166. The method of embodiment 94, wherein the bonded abrasive body comprises not greater than 50 vol % agglomerated primary abrasive particles for a total volume of the bonded abrasive body or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % agglomerated primary abrasive particles for a total volume of the bonded abrasive body.

Embodiment 167. The method of embodiment 94, wherein the bonded abrasive body has a density of at least 2.05 g/cm³ or at least 2.10 g/cm³ or at least 2.15 g/cm³ or at least 2.20 g/cm³ or at least 2.25 g/cm³ or at least 2.30 g/cm³.

Embodiment 168. The method of embodiment 94, wherein the bonded abrasive body has a density of no greater than 2.50 g/cm³ or no greater than 2.45 g/cm³ or no greater than 2.40 g/cm³ or no greater than 2.35 g/cm³ or no greater than 2.30 g/cm³.

Embodiment 169. The method of embodiment 94, wherein the bonded abrasive body has a thickness of at least 4.0 mm or 4.1 mm or 4.2 mm or 4.3 mm or 4.4 mm or 4.5 mm or 4.6 mm or 4.7 mm or 4.8 mm or 4.9 mm 5.0 mm or 5.1 mm or 5.2 mm or 5.3 mm or 5.4 mm or 5.5 mm or 5.6 mm or 5.7 mm or 5.8 mm or 5.9 mm or 6.0 mm or 6.1 mm or 6.2 mm or 6.3 mm or 6.4 mm or 6.5 mm or 6.6 mm or 6.7 mm or 6.8 mm or 6.9 mm or 7.0 mm.

Embodiment 170. The method of embodiment 94, wherein the bonded abrasive body has a thickness of not greater than 8.0 mm or not greater than 7.9 mm or not greater than 7.8 mm or not greater than 7.7 mm or no greater than 7.6 mm or not greater than 7.5 mm or not greater than 7.4 mm or not greater than 7.3 mm or not greater than 7.2 mm or not greater than 7.1 mm or not greater than 7.0 mm or not greater than 6.9 mm or not greater than 6.8 mm or not greater than 6.7 mm or no greater than 6.6 mm or not greater than 6.5 mm or not greater than 6.4 mm or not greater than 6.3 mm or not greater than 6.2 mm or not greater than 6.1 mm or not greater than 6.0 mm or not greater than 5.9 mm or not greater than 5.8 mm or not greater than 5.7 mm or no greater than 5.6 mm or not greater than 5.5 mm or not greater than 5.4 mm or not greater than 5.3 mm or not greater than 5.2 mm or not greater than 5.1 mm or not greater than 5.0 mm.

Embodiment 171. The method of embodiment 94, wherein the bonded abrasive body has a diameter of at least 75 mm or at least 80 mm or at least 85 mm or at least 90 mm or at least 95 mm or at least 100 mm or at least 105 mm or at least 110 mm or at least 115 mm or at least 120 mm or at least 125 mm or 150 mm or at least 180 mm or at least 230 mm.

Embodiment 172. The method of embodiment 94, wherein the bonded abrasive body has a diameter of not greater than 275 mm or not greater than 270 mm or not greater than 265 mm or not greater than 260 mm or not greater than 255 mm or not greater than 250 mm or not greater than 245 mm or not greater than 240 mm or not greater than 235 mm or not greater than 230 mm.

Embodiment 173. The method of embodiment 94, wherein the bonded abrasive a vibration factor of less than 8.2 m/s² or less than 8.1 m/s² or less than 8.0 m/s² or less than 7.9 m/s² or less than 7.8 m/s² or less than 7.7 m/s² or less than 7.6 m/s² or less than 7.5 m/s² or less than 7.4 m/s² or less than 7.3 m/s² or less than 7.2 m/s² or less than 7.1 m/s² or less than 7.0 m/s².

Embodiment 174. The method of embodiment 94, wherein the bonded abrasive a vibration factor of at least 1 m/s² or at least 2 m/s² or at least 3 m/s² or at least 3.5 m/s² or at least 4 m/s² or at least 4.5 m/s² or at least 5 m/s² or at least 5.5 m/s² or at least 6 m/s² or at least 6.5 m/s² or at least 7 m/s².

Embodiment 175. A method of using any abrasive article from embodiments 1-72, wherein the abrasive article has an MRR of at least 27 g/min or at least 28 g/min g/min or at least 29 g/min or at least 30 g/min or at least 31 g/min or at least 32 g/min or at least 33 g/min or at least 34 g/min or at least 35 g/min g/min or at least 36 g/min.

Embodiment 176. A method of using any abrasive article from embodiments 1-72, wherein the abrasive article has an MRR of no greater than 50 g/min or no greater than 48 g/min or no greater than 46 g/min or no greater than 44 g/min or no greater than 42 g/min or no greater than 40 g/min or no greater than 38 g/min or no greater than 36 g/min.

Embodiment 177. A method of using any abrasive article from embodiments 1-72, wherein the abrasive article has an SGE of at least 1.0 kJ/g or at least 1.1 kJ/g or at least 1.2 kJ/g or at least 1.3 kJ/g or at least 1.4 kJ/g or at least 1.5 kJ/g or at least 1.6 kJ/g or at least 1.7 kJ/g or at least 1.8 kJ/g or at least 1.9 kJ/g or at least 2.0 kJ/g or at least 2.1 kJ/g or at least 2.2 kJ/g or at least 2.3 kJ/g or at least 2.4 kJ/g or at least 2.5 kJ/g.

Embodiment 178. A method of using any abrasive article from embodiments 1-72, wherein the abrasive article has an SGE of no greater than 4.0 kJ/g or no greater than 3.9 or no greater than 3.8 or no greater than 3.7 or no greater than 3.6 or no greater than 3.5 or no greater than 3.4 or no greater than 3.3 or no greater than 3.2 or no greater than 3.1 or no greater than 3.0 or no greater than 2.9 or no greater than 2.8 or no greater than 2.7 or no greater than 2.6 or no greater than 2.5.

Embodiment 179. The method of embodiment 94, wherein the bonded abrasive body comprises a mean pore spacing distance of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 180. The method of embodiment 94, wherein the bonded abrasive body comprises a mean pore spacing distance of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 181. The method of embodiment 94, wherein the bonded abrasive body comprises a pore spacing distance standard deviation of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 182. The method of embodiment 94, wherein the bonded abrasive body comprises a pore spacing distance standard deviation of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 183. The method of embodiment 94, wherein the bonded abrasive body comprises PS10 of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 184. The method of embodiment 94, wherein the bonded abrasive body comprises a PS10 of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 185. The method of embodiment 94, wherein the bonded abrasive body comprises PS25 of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 186. The method of embodiment 94, wherein the bonded abrasive body comprises a PS25 of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 187. The method of embodiment 94, wherein the bonded abrasive body comprises PS50 of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 188. The method of embodiment 94, wherein the bonded abrasive body comprises a PS50 of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 189. The method of embodiment 94, wherein the bonded abrasive body comprises PS75 of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 190. The method of embodiment 94, wherein the bonded abrasive body comprises a PS75 of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 191. The method of embodiment 94, wherein the bonded abrasive body comprises PS90 of at least 0.10 mm or at 0.12 mm or at least 0.14 mm or at least 0.16 mm or at least 0.18 mm or at least 0.20 mm or at least 0.22 mm or at least 0.24 mm or at least 0.26 mm or at least 0.28 mm or at least 0.30 mm or at least 0.32 mm or at least 0.34 mm or at least 0.36 mm or at least 0.38 mm or at least 0.40 mm or at least 0.42 mm or at least 0.44 mm or at least 0.46 mm or at least 0.48 mm or at least 0.50 mm or at least 0.55 mm or at least 0.60 mm or at least 0.65 mm or at least 0.70 mm or at least 0.75 mm or at least 0.80 mm or at least 0.85 mm or at least 0.90 mm or at least 0.95 mm or at least 1.0 mm or at least 1.1 mm or at least 1.2 mm or at least 1.3 mm or at least 1.4 mm or at least 1.5 mm or at least 1.6 mm or at least 1.7 mm or at least 1.8 mm or at least 1.9 mm or at least 2.0 mm or at least 2.1 mm or at least 2.2 mm or at least 2.3 mm or at least 2.4 mm or at least 2.5 mm or at least 2.6 mm or at least 2.7 mm or at least 2.8 mm or at least 2.9 mm or at least 3.0 mm or at least 3.1 mm or at least 3.2 mm or at least 3.3 mm or at least 3.4 mm or at least 3.5 mm or at least 3.6 mm or at least 3.7 mm or at least 3.8 mm or at least 3.9 mm or at least 4.0 mm or at least 4.1 mm or at least 4.2 mm or at least 4.3 mm or at least 4.4 mm or at least 4.5 mm or at least 4.6 mm or at least 4.7 mm or at least 4.8 mm or at least 4.9 mm or at least 5.0 mm.

Embodiment 192. The method of embodiment 94, wherein the bonded abrasive body comprises a PS90 of be not greater than 5.0 mm or not greater than 4.9 mm or not greater than 4.8 mm or not greater than 4.7 mm or not greater than 4.6 mm or not greater than 4.5 mm or not greater than 4.4 mm or not greater than 4.3 mm or not greater than 4.2 mm or not greater than 4.1 mm or not greater than 4.0 mm or not greater than 3.9 mm or not greater than 3.8 mm or not greater than 3.7 mm or not greater than 3.6 mm or not greater than 3.5 mm or not greater than 3.4 mm or not greater than 3.3 mm or not greater than 3.2 mm or not greater than 3.1 mm or not greater than 3.0 mm or not greater than 2.9 mm or not greater than 2.8 mm or not greater than 2.7 mm or not greater than 2.6 mm or not greater than 2.5 mm or not greater than 2.4 mm or not greater than 2.3 mm or not greater than 2.2 mm or not greater than 2.1 mm or not greater than 2.0 mm or not greater than 1.9 mm or not greater than 1.8 mm or not greater than 1.7 mm or not greater than 1.6 mm or not greater than 1.5 mm or not greater than 1.4 mm or not greater than 1.3 mm or not greater than 1.2 mm or not greater than 1.1 mm or not greater than 1.0 mm or not greater than 0.9 mm or not greater than 0.8 mm or not greater than 0.7 mm or not greater than 0.6 mm or not greater than 0.5 mm or not greater than 0.4 mm or not greater than 0.3 mm or not greater than 0.2 mm or not greater than 0.1 mm or not greater than 0.05 mm.

Embodiment 193. The method of embodiment 94, wherein the bonded abrasive body comprises an average neighboring pore count of at least 5.25 or at least 5.5 or at least 5.75 or at least 6 or at least 6.25 or at least 6.5 or at least 6.75 or at least 7 or at least 7.25 or at least 7.5 or at least 7.75 or at least 8 or at least 8.25 or at least 8.5 or at least 8.75 or at least 9.

Embodiment 194. The method of embodiment 94, wherein the bonded abrasive body comprises an average neighboring pore count of not greater than 20 or not greater than 19 or not greater than 18 or not greater than 17 or not greater than 16 or not greater than 15 or not greater than 14 or not greater than 13 or not greater than 12 or not greater than 11 or not greater than 10.

Embodiment 195. The method of embodiment 94, wherein the bonded abrasive body comprises a large neighboring pore count of at least 0.05 or at least 0.1 or at least 0.15 or at least 0.2 or at least 0.25 or at least 0.3 or at least 0.35 or at least 0.4 or at least 0.45 or at least 0.5 or at least 0.55.

Embodiment 196. The method of embodiment 94, wherein the bonded abrasive body comprises a large neighboring pore count of not greater than 2 or not greater than 1.9 or not greater than 1.8 or not greater than 1.7 or not greater than 1.6 or not greater than 1.5 or not greater than 1.4 or not greater than 1.3 or not greater than 1.2 or not greater than 1.1 or not greater than 1.0 or not greater than 0.9 or not greater than 0.8 or not greater than 0.7 or not greater than 0.6.

Embodiment 197. The method of embodiment 94, wherein the bonded abrasive body comprises a medium neighboring pore count of at least 1.4 or at least 1.5 or at least 1.6 or at least 1.7 or at least 1.8 or at least 1.9 or at least 2.0 or at least 2.1 or at least 2.2 or at least 2.3 or at least 2.4 or at least 2.5 or at least 2.6 or at least 2.7 or at least 2.8 or at least 2.9.

Embodiment 198. The method of embodiment 94, wherein the bonded abrasive body comprises a medium neighboring pore count of not greater than 5 or not greater than 4.75 or not greater than 4.5 or not greater than 4.25 or not greater than 4 or not greater than 3.75 or not greater than 3.5 or not greater than 3.25 or not greater than 3.

Embodiment 199. The method of embodiment 94, wherein the bonded abrasive body comprises a small neighboring pore count of at least 3.9 or at least 4.0 or at least 4.1 or at least 4.2 or at least 4.3 or at least 4.4 or at least 4.5 or at least 4.6 or at least 4.7 or at least 4.8 or at least 4.9 or at least 5.0 or at least 5.1 or at least 5.2 or at least 5.3 or at least 5.4 or at least 5.5 or at least 5.6 or at least 5.7 or at least 5.8 or at least 5.9 or at least 6.0 or at least 6.1 or at least 6.2 or at least 6.3 or at least 6.4.

Embodiment 200. The method of embodiment 94, wherein the bonded abrasive body comprises a small neighboring pore count of not greater than 10 or not greater than 9.5 or not greater than 9 or not greater than 8.5 or not greater than 8 or not greater than 7.5 or not greater than 7 or not greater than 6.5.

### EXAMPLES

### Example 1

Sample wheels were formed to analyze how pressing pressure and agglomerated particles affect the porosity, performance, and comfort of use of thin wheel abrasives.

Sample wheels S1-S4, were formed according to the following process. Agglomerated brown fused alumina was prepared by mixing brown fused alumina with 2-10 wt % inorganic binder. The mixture is then heated in a rotary kiln at 1050° C. to create agglomerated abrasive grains.

The agglomerated abrasive grains are then mixed with resol in a mixing bowl. This mixture is then further mixed with novolac resin and filler materials to produce a sample mixture. A comparative mixture, for a comparative wheel sample CS1 formed according to standard processes, was prepared using unagglomerated brown fused alumina. The contents of each mixture are below in Table 1.

TABLE 1

| | |
|---|---|
| S1 | CS1 |

Abrasive Grains

| | | | | |
|---|---|---|---|---|
| Agglomerated BFA | 65-75 | kg | 0 | kg |
| Unagglomerated BFA | 0 | kg | 65-75 | kg |

Resins

| | | | | |
|---|---|---|---|---|
| Resol | 3-7 | kg | 3-7 | kg |
| Novolac | 7-10 | kg | 7-10 | kg |

Fillers

| | | | | |
|---|---|---|---|---|
| Potassium Aluminum Fluoride | 13-17 | kg | 13-17 | kg |
| Faxam Oil | 0.1-0.3 | kg | 0.1-0.3 | kg |
| Carbon Black | 0.05-0.1 | kg | 0.05-0.1 | kg |

The mixtures were then sieved and left undisturbed to rest for 2 hrs. After resting, the mixtures are sieved again. The mixtures are then placed in a pressing mold. During this step, the sample mixture containing agglomerates must be continuously stirred in order to prevent aggregation. The sample mixture was pressed using the sample mixture at various pressures to form 4 sample green wheels. Comparative sample wheel CS1 was pressed using a standard pressing pressure. Pressing pressures for each sample can be seen below in Table 2.

TABLE 2

| Wheel | Pressing Pressure | |
|---|---|---|
| S1 | 150 | Bar |
| S2 | 80 | Bar |
| S3 | 150 | Bar |
| S4 | 0-60 | |
| CS1 | 150 | Bar |

The green wheels are then placed on a stacking bolt, separated by aluminum plates. For comparative samples using the standard process as well as sample S3, a spring and screw are attached to the bolt to compress the wheels. However, for wheels S1, S2, and S4, the wheels are only stacked on the stacking bolt without being compressed.

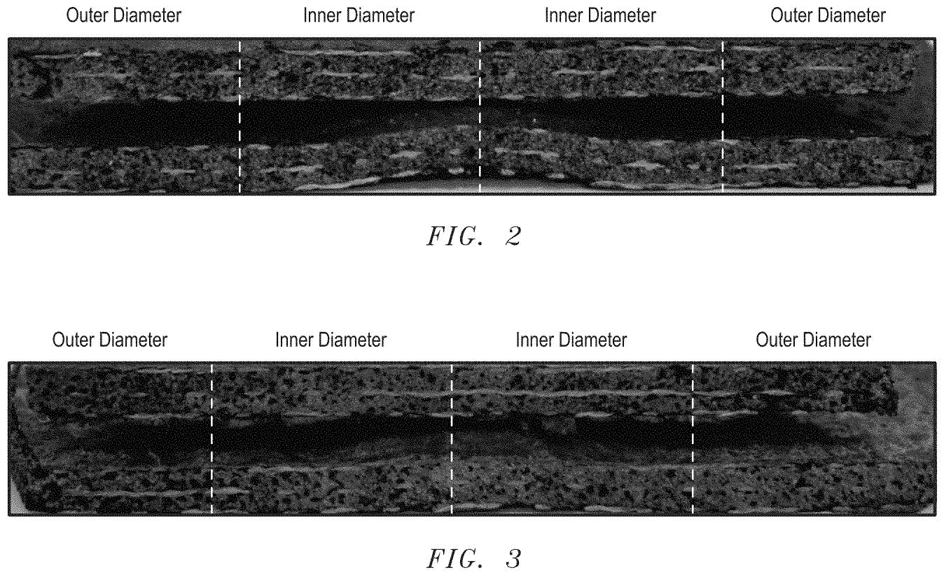

The green wheels are then cured for up to a day with a maximum temperature of 175° C. to create finally formed sample wheels S1-S4 and comparative sample wheel CS1. Cross-sections of S1 and S2 can be found in FIGS. 2 and 3, respectively. Cross-sections of samples S1-S3 and CS1 were prepared by cutting the wheels with a stationary saw. The length for each cut was about 123 mm for each wheel. Images were taken of each cross-section and then analyzed using ImageJ to identify the porosity of each sample. The same software was used to count the number and size of the pores. Pores were identified as either small (0.175 mm or less), medium (0.175-1.06 mm), or large (over 1.06 mm). Pores were also identified as being within the inner diameter of the wheel or outer diameter as shown in FIGS. 2 and 3. Porosity distribution factors were calculated for each sample by dividing the difference between the amount of inner diameter porosity and outer diameter porosity by the total amount of porosity. Porosity data for samples S1-S3 and CS1 can be seen in Table 3 below.

TABLE 3

| | S1 | S2 | S3 | CS1 |
|---|---|---|---|---|
| Porosity vol % | 14% | 30% | | 12% |
| Small porosity % | 27.4% | 12.3% | 72% | 46% |
| Large porosity % | 54.1% | 60.6% | 16.6% | 14.8% |
| Large/Small ratio | 1.97 | 4.91 | 0.23 | 0.31 |
| Large porosity | 0.42 | 0.18 | 0.08 | 1 |
| distribution factor | | | | |
| Total Porosity | 0.37 | 1.09 | 0.08 | 0.26 |
| distribution factor | | | | |

The wheels had their burst speed tested and all exceeded the standard burst speed requirements but for S4. The wheels had their porosity measured using image analysis software.

Neighboring pore data was also collected on cross sections of S2 and S3 according to the following process. Each pore was identified. A circle with radius of 0.56 mm surrounding the center of each pore was identified and the number of pores with having at least a portion of their volume the circle was counted. Pores were also identified as small, medium, or large according to the sizes noted above. Results can be found in Table 4 below.

TABLE 4

| | S2 | S3 |
|---|---|---|
| Average total | 9.97 | 5.21 |
| neighboring pores | | |
| Average small | 6.42 | 3.86 |
| neighboring pores | | |
| Average medium | 2.98 | 1.34 |
| neighboring pores | | |
| Average large | 0.57 | 0.01 |
| neighboring pores | | |

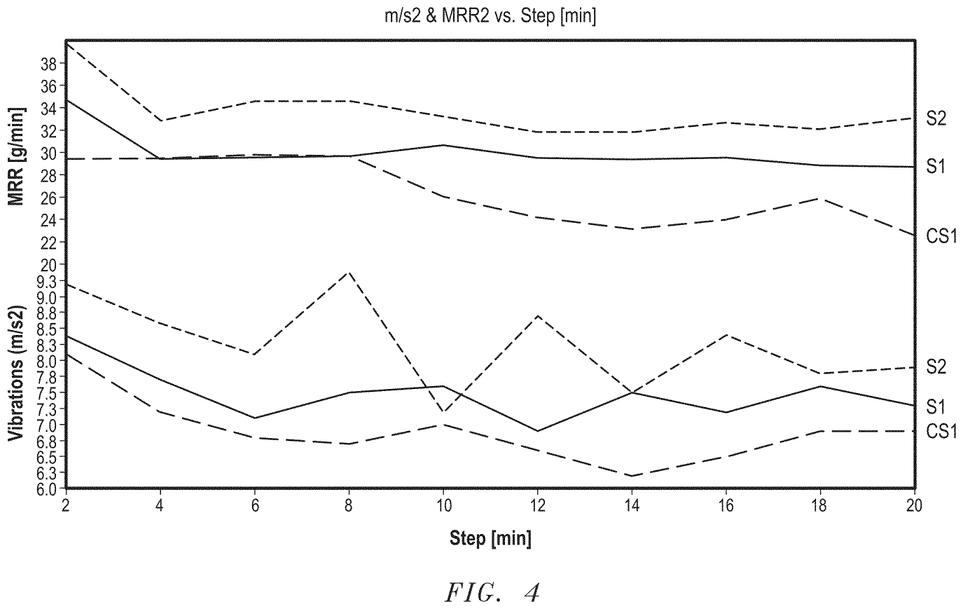

Samples S1, S2, and CS1 were used to grind a steel workpiece for 20 minutes; during this time, the material removal rate was measured at 2-minute intervals to track performance and the number of vibrations was tracked to measure comfort. Vibrations were measured using a Saint-Gobain Abrasives Smartwatch. The mean amount of vibrations per second was measured in 2 minute interval was tracked. The resulting data can be seen in FIG. 4. Notably, Samples S1 and S2 performed better while having less vibrations as compared to CS1. Without wishing to be tied to a particular theory, it is believed that the increase in well distributed large and medium porosity contributes to the increased comfort of use of the sample wheels.

Pore spacing distributions for Samples S1-S4 and CS1 are being determined. Pore spacing can be determined by imaging an article in 3D with a resolution of 3 μm/voxel using an X-ray computed-tomography scanner (VTomeX from GE). The pore detection can be based on a grey level segmentation. Neighboring pores can be identified using Delaunay triangulation (See Golias, N. A., & Dutton, R. W. (1997). Delaunay triangulation and 3D adaptive mesh generation. Finite elements in analysis and design, 25 (3-4), (331-341.) Pore spacing can alternatively be measured using a 2D cross section. When using a 2D cross section, the distance between each pore and its closest neighbor can be measured. The distance between neighboring pores can be measured using image analysis software and the distribution can be plotted.

The above-disclosed subject matter is to be considered illustrative, and not restrictive, and the appended items are intended to cover all such modifications, enhancements, and other embodiments, which fall within the true scope of the present invention. Thus, to the maximum extent allowed by law, the scope of the present invention is to be determined by the broadest permissible interpretation of the following items and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

What is claimed is:

1. An abrasive article comprising:
a bonded abrasive body having a ratio of diameter to thickness of at least 10:1 the body comprising:
secondary abrasive particles contained in a bond material, wherein the secondary abrasive particles comprise agglomerated primary abrasive particles;
wherein the abrasive article has a diameter D (mm), a mean vibration factor of no greater than 8.25 m/s², and a burst speed of at least 18700-D*54 min⁻¹.

2. The abrasive article of claim 1, wherein the ratio of large porosity to small porosity is at least 0.4 and no greater than 10.

3. The abrasive article of claim 1, wherein at least 18% of the porosity is large porosity.

4. The abrasive article of claim 1, wherein the bonded abrasive body comprises a large porosity distribution factor of no greater than 0.95.

5. The abrasive article of claim 1, wherein the bonded abrasive body comprises a porosity distribution factor of no greater than 0.35.

6. The abrasive article of claim 1, wherein the bonded abrasive body comprises a large porosity distribution factor of no greater than 0.95 and wherein at least 18% of the porosity is large porosity.

7. The abrasive article of claim 1, wherein the bonded abrasive body comprises a burst speed of not greater than 35000-D*100 min⁻¹.

8. The abrasive article of claim 1, wherein the bonded abrasive body is free of unagglomerated abrasive particles.

9. The abrasive article of claim 1, wherein the agglomerated primary abrasive particles comprise primary abrasive particles and a binder.

10. The abrasive article of claim 9, wherein the primary abrasive particles comprise brown fused alumina.

11. The abrasive article of claim 1, wherein the bond material comprises an organic bond material.

12. The abrasive article of claim 1, wherein the bonded abrasive body does not include pore-forming materials.

13. The abrasive article of claim 1, wherein the bonded abrasive body comprises closed porosity.

14. The abrasive article of claim 1, having a vibration factor of less than 8.2 m/s².

15. The abrasive article of claim 1, having a vibration factor of at least 1 m/s².

16. A method of making an abrasive article comprising:
providing a mixture that includes agglomerated primary abrasive particles and bond material,
pressing the mixture into a green abrasive body,
and curing the green abrasive body to form an abrasive article,
wherein the bonded abrasive body comprises a ratio of diameter to thickness of at least 10:1,
wherein the body further comprises secondary abrasive particles contained in a bond material, wherein the secondary abrasive particles comprise agglomerated primary abrasive particles;
wherein the abrasive article has a mean vibration factor of no greater than 8.25 m/s2 and a burst speed of at least 18700-D*54 min⁻¹.

17. The method of claim 16, wherein the mixture is pressed with a pressure of at least 30 bar.

18. The method of claim 16, wherein the mixture is pressed with a pressure of no greater than 275 bar.

19. A method of using the abrasive article of claim 1, wherein the abrasive article has an MRR of at least 27 g/min.

20. A method of using the abrasive article of claim 1, wherein the abrasive article has an MRR of no greater than 50 g/min.
